(19) United States
(12) Patent Application Publication
(10) Pub. No.: US 2025/0365585 A1
(43) Pub. Date: Nov. 27, 2025

(54) APPARATUS AND METHOD FOR SENSING-BASED CONDITIONAL TRANSMISSION CONFIGURATION

(71) Applicant: LENOVO (SINGAPORE) PTE LIMITED, SINGAPORE (SG)

(72) Inventors: Seyedomid TAGHIZADEH MOTLAGH, Oberursel (DE); Vijay NANGIA, Woodridge, IL (US); Ali Ramadan ALI, Kraiburg am Inn (DE)

(21) Appl. No.: 18/674,582

(22) Filed: May 24, 2024

(51) Int. Cl. H04W 24/02; H04W 24/10; H04W 68/02

(52) U.S. Cl. CPC H04W 24/02; H04W 24/10; H04W 68/02

(57) ABSTRACT

Certain aspects of the present disclosure relate to a radio node for wireless communication, comprising at least one memory, and at least one processor coupled with the at least one memory and configured to cause the radio node to receive, from a network entity, a configuration comprising a condition for outputting a second signal using at least one metric of a received sensing signal, receive a first sensing signal, measure the at least one metric of the first sensing signal, determine whether the condition is satisfied using the at least one metric, determine transmission parameters for a second signal based on the determination of whether the condition is satisfied, and transmit the second signal using the transmission parameters.

### TECHNICAL FIELD

The present disclosure relates to wireless communications, and more specifically to conditional sensing operations.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

The wireless communications system, including one or more communication devices, can perform sensing to improve performance of the system (e.g., network) and/or support various services and/or applications. The one or more communication devices may be configured to support radio sensing, in which the one or more communication devices may obtain (e.g., collect, receive) information associated with an environment by emitting (e.g., outputting, transmitting) radio frequency (RF) signals. For example, the one or more communication devices may emit one or more RF signals to detect objects or areas (e.g., zones) within the environment, such as another device (e.g., a UE) or a physical location within the environment that includes the device or other devices. Some examples (e.g., mechanism, method, scheme, technique) of RF sensing may include transmission of a sensing signal (e.g., a sensing reference signal) from a transmitter node (also referred to as a sensing transmitter (Tx) node), which may be a network entity and/or UE, reception of reflections (e.g., echoes) of the transmitted sensing signal by a receiver node (also referred to as a sensing receiver (Rx) node), which may be a network entity and/or UE. Additionally, RF sensing may include processing of the received reflections to determine or infer information associated with the environment or objects (e.g., devices) within the environment.

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

Some implementations of the method and apparatuses described herein may further include a radio node for wireless communication, comprising at least one memory, and at least one processor coupled with the at least one memory and configured to cause the radio node to receive, from a network entity, a configuration comprising a condition for outputting a second signal using at least one metric of a received sensing signal, receive a first sensing signal, measure the at least one metric of the first sensing signal, determine whether the condition is satisfied using the at least one metric, determine transmission parameters for a second signal based on the determination of whether the condition is satisfied, and transmit the second signal using the transmission parameters.

In some implementations of the method and apparatuses described herein, the configuration further comprises at least one of parameters for receiving the first sensing signal and the at least one metric.

In some implementations of the method and apparatuses described herein, the condition comprises at least one of: a target, a path or a path group being present; a measurement value being larger than a threshold value; a measurement value being smaller than a threshold value; and a feature of a detected object being present.

In some implementations of the method and apparatuses described herein, the at least one processor is further configured to cause the radio node to: measure a power value of the first sensing signal; compare the power value to a first threshold value and a second threshold value; and when the measured power value is above the first threshold value and below the second threshold value, use a transmission power that is higher than the measured power value to transmit the second signal.

In some implementations of the method and apparatuses described herein, the at least one metric of the first sensing signal is at least one of an angle of arrival and an azimuth of arrival, and the at least one processor is further configured to cause the radio node to: measure the at least one of the angle of arrival and the azimuth of arrival of the first sensing signal; and transmit the second signal in a direction corresponding to the at least one of the angle of arrival and the azimuth of arrival.

In some implementations of the method and apparatuses described herein, the radio node is associated with a radio access technology (RAT)-independent sensor, and the at least one processor is further configured to cause the RAT-independent sensor to sense a target or features of a target.

In some implementations of the method and apparatuses described herein, the configuration further comprises instructions for sensing a detected object using the RAT-independent sensor, and the at least one processor is further configured to cause the radio node to transmit, to the network entity, a signal indicating at least one of a type, a capability, and sensing data of the RAT-independent sensor.

In some implementations of the method and apparatuses described herein, the at least one processor is further configured to cause the radio node to determine at least one of whether the condition is satisfied and the transmission parameters for the second signal using sensing data from sensing the target or features of the target with the RAT-independent sensor.

In some implementations of the method and apparatuses described herein, the second signal is a carrier wave for a backscattering device.

In some implementations of the method and apparatuses described herein, the second signal is a paging signal for paging a second radio node at a location of a detected object or a communication signal transmitted on a physical control channel for communicating with the second radio node at the location of the detected object.

In some implementations of the method and apparatuses described herein, the second signal is a sounding reference signal (SRS) or a positioning reference signal (PRS).

In some implementations of the method and apparatuses described herein, the configuration from the network entity further comprises information for transmitting a third signal that shares radio resources with the second signal, and the at least one processor is further configured to cause the radio node to transmit the third signal based on the configuration received from the network entity.

In some implementations of the method and apparatuses described herein, the third signal is duplexed with the second signal in the time domain, and the third signal is transmitted to a second radio node.

In some implementations of the method and apparatuses described herein, the at least one processor is further configured to cause the radio node to transmit a signal indicating the determined transmission parameters for the second signal to at least one of the network entity, a recipient of the second signal, and a second radio node.

In some implementations of the method and apparatuses described herein, the at least one processor is further configured to cause the radio node to measure a first power value associated with a path to a target; measure a second power value of received power not associated with the path to the target; and transmit, to the network entity, an indication of the first power value and the second power value.

### BRIEF DESCRIPTION OF THE DRAWINGS

FIG. 1 illustrates an example of a wireless communications system in accordance with aspects of the present disclosure.

FIG. 2 illustrates an example of radio sensing by radio nodes in accordance with aspects of the present disclosure.

FIG. 3 illustrates an example of a signal diagram in accordance with aspects of the present disclosure.

FIG. 4 illustrates an example of an example of a RTT or RTD measurement process in accordance with aspects of the present disclosure.

FIG. 5 illustrates an example of an RTT or RTD measurement process using transmission parameter adjustments in accordance with aspects of the present disclosure.

FIG. 6 illustrates an example of an example of an RTT or RTD measurement process with sensing-based adjustments in accordance with aspects of the present disclosure.

FIG. 7 illustrates an example of sensing operations of three nodes in accordance with aspects of the present disclosure.

FIG. 8 illustrates an example of sensing operations of three nodes in accordance with aspects of the present disclosure.

FIG. 9 illustrates an example of a user equipment (UE) 900 in accordance with aspects of the present disclosure.

FIG. 10 illustrates an example of a processor 1000 in accordance with aspects of the present disclosure.

FIG. 11 illustrates an example of a network equipment (NE) 1100 in accordance with aspects of the present disclosure.

FIG. 12 illustrates a flowchart of a method performed by a node in accordance with aspects of the present disclosure.

### DETAILED DESCRIPTION

A Node (also referred to as a radio node) may be a user equipment (UE) (e.g., any device or processing circuitry of the device described herein) and/or a network equipment (NE) (e.g., any base station or network entity or processing circuitry of the device described herein) that supports aspects of the present disclosure. The node may support sensing, which may include obtaining sensing information (e.g., measurements) based on emitting (e.g., broadcasting, transmitting, outputting) one or more radio signals and collecting measurements based on the emitted radio signals to obtain the sensing information of objects (also referred to as target objects), sensing information associated with an environment, and/or sensing information of one or more radio nodes. Additionally, radio sensing may enable the node to obtain (e.g., measure) other sensing information (e.g., characteristics), such as position, velocity, direction/heading, orientation, radar cross-section (RCS), shape, material, etc., of an object or another node, for example, by transmitting a sensing signal (e.g., a sensing reference signal (RS)) from an NE and/or a UE (e.g., a sensing Tx node), receiving reflections of the transmitted sensing signal by the NE and/or the UE (e.g., a sensing Rx node), and processing the received reflections to determine or infer information associated with the environment.

In some cases, sensing information obtained by a node can provide for efficient and accurate operations for subsequent sensing (e.g., collecting sensing measurements), as well as improve reliability of wireless communication (e.g., transmission and/or reception of data and control information over a channel, such as downlink channel, uplink channel, sidelink channel, etc.). By way of example, a node may determine a presence of a target object (e.g., another node, which may be a UE) based on performing a sensing procedure (e.g., a sensing measurement process), and as a result the node may perform additional sensing operations (e.g., measurements, transmissions). Additionally, or alternatively, the presence of the target object may be a trigger event for the node to perform the additional sensing operations and/or modify (e.g., update, adjust) one or more parameters of the sensing procedure. In other examples, a node may determine a presence of a target object (e.g., another node, which may be a UE), which may block a path (also referred to as a radio path, a transmission path, a reception path, a propagation path, a signal path) and impact reliability of transmission and reception of signaling to and from the node. In some cases, the node may perform a beam management procedure (e.g., a beam switch procedure, or the like) in response to (e.g., based at least in part on) the block. For instance, the node may determine and select one or more beams to switch to that are not impacted by the block. In other words, the node may trigger a beam management procedure to utilize one or more beams that are robust to the blockage caused by the target object (e.g., capable of effective communication despite blockage).

Various aspects of the present disclosure provide for one or more nodes, such as a UE (e.g., any device or processing circuitry of the device described herein) and/or a NE (e.g., any base station or network entity or processing circuitry of the device described herein) to support one or more sensing operations (or sensing procedures) that provide for improved accuracy and efficiency. For example, a node as described herein may adapt (e.g., monitor, track, update, modify) one or more parameters associated with signals (e.g., transmitted signals), which may be configured (e.g., dedicated) sensing signals and/or data or control signals. The node may adapt one or more parameters based at least in part on sensing information obtained by the node to improve energy efficiency and accuracy of sensing operations, as well as the improved robustness and energy consumption of the physical channel processes for transmitting data and control information.

Aspects of the present disclosure are described in the context of a wireless communications system.

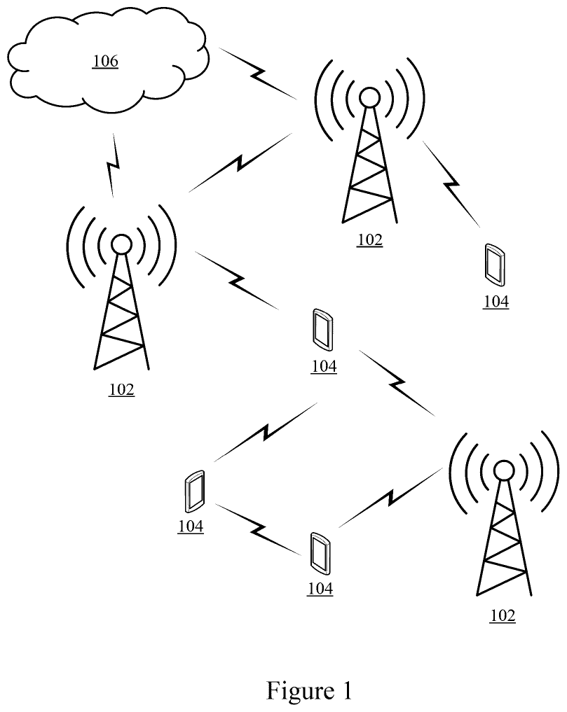

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas 112 associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

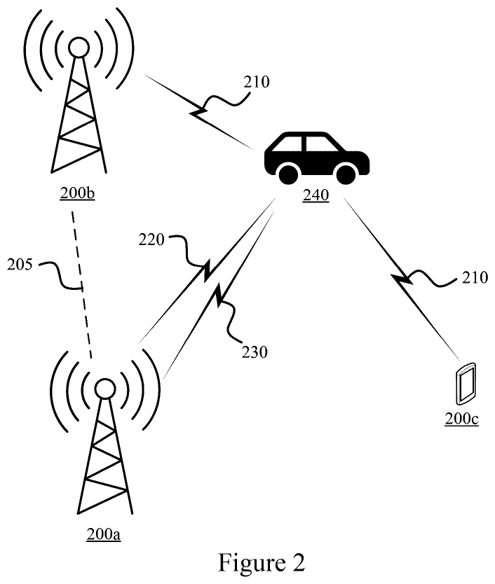

FIG. 2 illustrates an example of radio sensing by radio nodes 200 in accordance with aspects of the present disclosure. In the example of FIG. 2, a first radio node 200a, a second radio node 200b and a third radio node 200c each transmit sensing signals 210. Each of the radio nodes may be a base station such as a gNB, user equipment such as a cellular telephone or a vehicle, a remote radio head (RRH), a transmission reception point (TRP), a reconfigurable intelligent surface (RIS), a relay node, a wireless repeater, a network controlled repeater (NCR), a vehicle mounted relay (VMR), a wireless access backhaul (WAB), a Femto node, an integrated access backhaul (IAB) etc. In some embodiments, one or more of the radio nodes 200 communicates with one or more of the other radio nodes using a physical connection such as an X2 interface 205. In some examples, one or more node 200 may correspond to a network node and can have reconfigurable surface technology where its response can be controlled dynamically and/or semi-statically through control signaling such as to tune the incident wireless signals through reflection, refraction, focusing, collimation, modulation, absorption, or any combination of these, and thus can be adapted to the status of the propagation environment.

The sensing signals 210 reflect off an object 240 as a first signal 220 (e.g., a first sensing signal) and are received by the first radio node 200a. The object 240 in FIG. 2 is a car, but the object can be any type of vehicle including a uncrewed aerial vehicle (UAV), a boat, a bicycle, etc. The object 240 can be any physical object, including a person, animal, tree, a structure such as a house, building, post, or wall, etc.

In an embodiment, a radio node 200 is configured to receive a first sensing signal 220 and transmit a second signal 230 that may be a sensing signal (e.g., by which a sensing target/object presence or features such as location, velocity, shape, orientation etc. may be detected) or a signal on a physical channel containing data or control information. The transmission or transmission parameters of the second signal 230 may be configured to be determined based on detection of the presence or features of an object 240 (e.g., a sensing target) by the radio node based on the reception of first sensing signal 220.

In an embodiment, a radio node 200 which performs radio sensing measurements is configured with parameters for receiving a first sensing signal 220. The parameters may include one or more of time-frequency resources, sequence type, parameters of physical layer mapping, an ID of a previously defined signal, etc. The first sensing signal 220 may be on a physical data or control channel such as a physical downlink shared channel (PDSCH) or a physical downlink control channel (PDCCH). The first sensing signal 220 may be a sidelink (SL), uplink (UL) or downlink signal. In some embodiments, the first sensing signal 220 is a reference signal (RS) transmitted in the SL, DL, UL, or TRP-to-TRP directions.

The radio node 200 may be configured with metrics to measure and/or conditions to be determined by the radio node 200 based on the reception of the first sensing signal 220. Accordingly, the radio node 200 may be configured with a first set of one or more parameters for reception and measurement of signals. At least one parameter of the first set of one or more parameters may indicate a metric of a received sensing signal for measurement.

In addition, the radio node 200 may be configured with parameters for transmitting a second signal 230 (e.g., including parameters defining transmission power, transmission beam, transmission signal type, transmission SCS, RS ID/type, configuration parameters of a physical channel containing data and control information). The second signal 230 may be the same type of signal as the first sensing signal 220. The parameters may be, for example, a reflection strategy (e.g., a reflection strategy implemented by an reconfigurable intelligent surface (RIS), including one or more of an angle of incidence, angle of reflection, power of reflection associated to a pair of incidence and reflection beams, etc.), or re-transmission (e.g., reception and transmission beams of a network control repeater (NCR)) of a second signal 230 by the radio node 200. The parameters may include, for example, parameters of the radio node 200 for transmitting, re-transmitting or reflecting of the second signal 230 based on the conditions and/or measurement values determined by the radio node 200 based on the first sensing signal 220.

In some embodiments, the measurement values of the first sensing signal 220 may include one or more of: power values (e.g., Reference Signal Received Power (RSRP) or Reference Signal Received Path Power (RSRPP)), delay, doppler shift, Angle of Arrival (AoA), Zenith of Arrival (ZoA), vibration rate associated to a defined (e.g, a defined path via a path ID referencing to a reported/detected or defined or known path, or path parameters defining a detected path such as a path angle (azimuth/elevation) or angle range, path doppler shift or range of expected doppler shift values), indicated or detected path or path group (e.g., detected or indicated group of paths associated to a detected/tracked target or path parameters), etc. The vibration rate may be associated with micro-doppler measurements and used to determine whether one or more of path distance, phase, frequency, amplitude/strength is fluctuating (e.g., periodically changing) over time.

In some embodiments, metrics may be measured with respect to one or more condition (e.g., measurements involving paths corresponding to an indicated range of angle, delay, doppler, vibration rate, etc.).

In some embodiments, the measurement values may be measured relative to a another indicated or known measurement at the radio node 200. The other measurement may be of one or more of a different time, path, signal, frequency band, etc. Examples include: 1) measurement of time of arrival (ToA) different from a detected or indicated sensing path and the line of sight (LOS) path based on reception of the first sensing signal 220; and 2) relative sum-RSRP or RSRPP of all paths within an indicated angle range measured at the current time instance compared to data from a previous time instance. The data from a previous time instance may be data of a different sensing signal measured previously, or a different instance of the same first sensing signal 220 which is observed at a different time instance, e.g., when the first sensing signal 220 is a periodic signal and repeated at different time instances of the subframes or 1 msec.

In some embodiments, a signal to interference and noise ratio (SINR) or similar value of a sensing target is measured by the radio node 200 based on the received first sensing signal 220. The SINR value may be reported by the radio node 200 to a network entity, e.g., an entity such as a sensing management function (SensMF). The SINR value may be used as a measure of sensing measurement quality, and the SensMF may determine the reliability or accuracy of the sensing measurement process or the sensing results at least in part based on the reported SINR value.

The SINR may be used to determine the observability of a sensing target by the radio node 200. In an embodiment, the SINR may comprise a ratio of the measured sensing signal power at the radio node 200 relative to the total received power or the undesired received power. Examples of the measured sensing signal power include the total sensing signal power, and the received power of the first sensing signal 220 associated to a sensing target, e.g., a power of an indicated or detected path or path group. In some instances, the sensing signal power may be a sum of the RSRPP of one or more indicated or detected path associated to a sensing target.

In an embodiment, a radio node 200 measures a first power value associated with a path to a target, measures a second power value of received power not associated with the path to the target, and transmits, to a network entity, an indication of the first power value and the second power value. The indication may be a ratio between the two power values or comprise an indication of each power value.

The undesired received power may include one or more of the following types of received power. In some embodiments, the received power includes white, additive or thermal noise power. In some embodiments, the received power includes interference from signal transmissions other than the first sensing signal 220 such as downlink data transmitted by a TRP not related to the sensing operation which shares all or a subset of the resources with the first sensing signal 220.

In some embodiments, the received power includes interference from the self-transmission of a resource shared with the reception of the first sensing signal 220 (e.g., self-interference, after or before cancellation at the radio node 200).

In some embodiments, the received power includes interference from sensing signal transmissions from other paths not associated to a target. For example, the undesired received power may comprise instances of the first sensing signal 220 which are received directly from other radio nodes 200 without reflecting off the object 240 or a similar target, or instances of the first sensing signal 220 which are reflected off surfaces other than the object 240 or a similar target. Such instances of undesired power may be detected by measuring one or more of the AoA, ZoA, power, or time of the signals, and comparing those measurements to a range of values associated with the sensing area of interest observable at the radio node 200. In one example, the SINR is measured as a ratio of the sum of the RSRPP of the paths associated with an indicated angle and/or delay range, to the sum of the RSRPP of the all other detected paths.

The SINR may be measured based on the observed received interference power after interference suppression of one or more of the above undesired received power sources indicated above, depending on the capability of the radio node 200.

In some embodiments, the reported SINR may be associated with one or more capability of a radio node 200 for successive interference estimation and cancellation of the external signals, for paths associated with target-unrelated clutters, for self-interference, or in band or adjacent band leakage cancellation due to the self-transmission by the radio node 200. In one example, a first SINR value is reported for a first indicated capability of the radio node and further, a second SINR value is reported for a second indicated capability of the radio node (e.g., SINR with and without estimation-and-suppression of a received LOS path or received self-Interference).

A radio node 200 may determine parameters for transmitting a second signal 230 by determining whether a condition is satisfied. The condition may be indicated to the radio node 200 in a configuration message.

In some embodiments, the condition may be defined with respect to comparing a measurement value to one or more maximum and/or minimum threshold value. For example, the condition may be met if an RSRP or sum-RSPP of measured paths associated to a zenith or azimuth range of interest (associated to a sensing target area) observable at the radio node 200 have experienced a growth of an at least an indicated absolute or relative energy level.

In some embodiments, the condition may be an outcome of artificial intelligence or machine learning (AI/ML) model processing of the received first sensing signal 220 and/or a measurement of the first sensing signal 220 by the radio node 200. Examples of scenarios associated with AI/ML model processing include detection of the blockage potential of a beam, of the presence of a vehicle in an indicated direction, of a human gesture etc.

In some embodiments, the condition may be satisfied based on the presence of a target which is determined by the radio node 200 without explicit relation to a performed sensing measurement of the first sensing signal 220. For example, the presence of a vehicle, detection of an intruder in a vehicle pathway, etc. may be detectable by a radio node 200 using an AI/ML model with input of the first sensing signal 220 or a RAT-independent sensor data input accessible to the radio. Examples of RAT-independent sensors which can collect such sensor data include cameras, motion sensors, RADAR sensors, and RGB sensors, which may be accessible to the radio node 200 via higher layer information.

In some embodiments, the conditions to be determined by the radio node 200 are based on one or more of the measurement values include one or more of: a target or a path or a path group being present, a measurement value being larger than an indicated threshold, a measurement value being smaller than an indicated threshold, and a feature of a detected target being present or a condition being true. Examples of a detected target being present or condition being true include a gesture of a human body determined via a computational AI/ML model, a target orientation, shape, size, volume, dimension, heading, velocity, a target type being a human, vehicle, or animal, to name a few.

In some embodiments, the condition or parameters associated to a target or paths associated with a target are determined, at least in part, based on the RAT-independent sensor data available to the radio node 200, the availability of such data, and/or the capability of the radio node 200 to adjust transmission, reception and reflection of signals.

In some embodiments, the parameters discussed above may be self-determined by the radio node 200 (e.g., when the radio node 200 is a controller node of a sensing measurement operation, when a radio node 200 determines a configuration parameter autonomously, based on available RAT-Independent measurement data, etc.).

In an embodiment, the parameters discussed above may be preconfigured. For example, one or more of the parameters may be known at the radio node 200 or determined based on a pre-configured value or procedure, etc.

The conditions, measurement values and/or parameters discussed above may be received by a first radio node 200a from a network entity 102, which may be a controller node or a radio node 200 other than the controller node. For example, parameters may be received from a serving gNB of a sensing operation, a controller entity of the sensing operation residing in the RAN or core network communicating with the radio node 200, another radio node 200 performing a sensing measurement, etc. When the parameters are received from a separate radio node 200, they may be received as configuration information or assistance information.

Accordingly, using the configuration parameters, a radio node 200 may perform reception of the first sensing signal 220, and perform measurements to determine the configured measurement values and/or whether a condition is satisfied based on reception of the first sensing signal 220. Next, the radio node 200 may skip a transmission or reflection of a second signal 230, adjust or determine parameters of a transmission, retransmission or reflection of a second signal 230, and then transmit or reflect the second signal 230 using the determined parameters.

In some embodiments, after determining that a condition is not satisfied, the radio node 200 may determine transmission parameters for a second signal 230. For example, after determining that a condition is not satisfied (e.g., a sensing target, object of interest and/or a defined path is not present), the radio node 200 may skip or not perform a transmission or reflection of an instance of the second signal 230. The transmission or reflection may be indicated to the radio node 200 to be conditioned on the condition being satisfied.

In an embodiment, the transmission parameters for a second signal 230 may include an angle or zenith of the beam such that the beam has a quasi-co location (QCL) relation to a detected path or target. The transmission parameters for a second signal 230 may include beam power. In an example, transmission power is reduced or eliminated when a measured power (e.g., of a path associated with a target sensing area) is below a first threshold value. In another example, beam power is set to a high level when a measured power (e.g., of a path associated with a target sensing area) is below a second threshold value and above a first threshold value. The high beam power may be higher than a received beam power of the first sensing signal 220. In some embodiments, the beam power is set to an indicated ratio to received power, increased by an increment compared to an initial transmission power, or increased by an increment according to an index of power levels indicated in a table of the transmitting node.

In another example, a ratio between the received beam power of the first sensing signal 220 of a detected path or target and the transmission power of the second signal 230 is 1:1. In other words, the transmission power of a beam to a detected path or target may be set to the power of a received beam associated with the detected path or target.

In an embodiment, the transmission parameters for a second signal 230 are selected from a set of indicated parameters (e.g., an indicated set of Tx beams, Tx power values or ratios, etc.) based on determined measurement values and/or conditions.

In an embodiment, a beam radiation pattern of a second signal 230 conveys less energy towards a target or area of interest associated with a defined condition or sensing target presence, e.g., when a transmission or reflection beam comprises multiple transmission or reflection beam directions and upon determination a condition is not satisfied (e.g., a target is not present or an RSRPP or sum-RSRPP of paths within a defined AoA, ZoA, ToA range, is below a first threshold) the transmission beam direction towards the target may be attenuated or removed from the beam pattern or a wider beam may be used containing less energy towards the expected target location but more energy towards the areas surrounding the expected target location.

In an embodiment, a beam radiation pattern of a second signal 230 conveys higher energy towards a target or area of interest associated with a condition or sensing target presence, e.g., when a beam comprising multiple transmission or reflection beam directions (with the same or different energy), and upon determination of a target not being observed by the radio node 200 or otherwise not being present, (e.g., based on an RSRPP or sum-RSRPP of the paths within a defined AoA, ZoA, ToA range being below a second threshold and/or above a first threshold, e.g., when a radio node 200 observes some minimal energy received according to an expected doppler, angle or delay range, however, not sufficient and below an indicated threshold to perform a particular sensing measurement type) the transmission beam direction towards a target may be amplified or assigned with a higher power in the beam pattern or within the total transmission power used by the radio node 200 for the transmission or reflection.

In an embodiment, an indicated configuration for second signal 230 may be employed based on a condition not being present. The second signal 230 may be transmitted on a downlink, uplink, or sidelink physical data or control channel which is transmitted (at the configured time/frequency resources of the second signal 230) based on the condition not being present.

In some embodiments, the conditions for determining parameters for a second signal 230 include two or more conditions. In some embodiments, the multiple conditions comprise a criterion associated with or indicating the presence or absence of a target (determined when a defined RSRP/RSRPP measurement is below an indicated first threshold) and a criterion associated with measurability of the target with respect to an indicated measurement type or measurement accuracy etc. (e.g., determined when a defined RSRP/RSRPP/SINR measurement is below a second threshold). In some embodiments, first and second conditions are mapped to different adjustments of the transmission parameters by a radio node 200 based on the determination of multiple conditions.

In some embodiments, the conditions are defined for the radio node 200 corresponding to whether a target or target feature is not detected to be present (e.g., a measured power is below a first threshold), whether the target or target feature is detected to be present but is not measurable with a desired or indicated accuracy (e.g., a measured power or SINR is below a second threshold but above a first threshold, or being measurable in view of one or more indicated measurements and/or measurement accuracy or reliability) or whether the target or target feature is both present and measurable. Of course, other conditions are possible.

In some embodiments, upon determining that a condition is present or satisfied, the radio node 200 determines parameters for a transmission beam such as beam width, angle, direction, and beam focusing when a near field (NF) spherical beam pattern can be used and the target position is also estimated at the sensing receiver, of a second signal 230 to the obtained measurement of the first signal (e.g., utilizing the Rx beam by which a path or path group associated to the sensing target is observed for transmission of the second signal 230, utilizing a Tx beam direction according to a detected AoA/ZoA of a path associated to a target, or utilizing a Tx beamwidth according to the perceived size of a detected target).

In some embodiments, upon determining a condition is present or satisfied, the radio node 200 determines parameters of a second sensing signal according to measurements of the first signal. For example, a higher transmission power and/or a narrower beam in the direction of the detected path/target may be employed for a second signal 230 which is a sensing signal when the received power is below a threshold.

In some embodiments, upon determining a condition is present or satisfied, the radio node 200 determines time parameters for a second signal 230. For example, the radio node 200 may adjust transmission timing of a second sensing signal to the measured first sensing signal 220 (e.g., transmission of the second signal 230 after an indicated time window or from the start of a subframe at which the transmission of the second signal 230 is expected with a delay according to a measured ToA of a path associated with the sensing target). In some embodiments, the radio node 200 determines frequency parameters, for example by adjusting a transmission frequency of a second signal 230 based on the measured first sensing signal 220.

In some embodiments, the determination of whether a condition is satisfied is performed, at least in part, using RAT-independent measurement data available to higher layers of the radio node 200 (e.g., measurement readings of a camera, acoustic, LIDAR or other non-radio sensor of the radio node 200). In some embodiments, the RAT-independent measurements are used as a stand-alone source of measurement, and the configuration and or reception of the first sensing signal 220 may be skipped for some such embodiments.

In other embodiments, RAT-independent measurements are used together with the measurement of the first sensing signal 220 to determine whether a condition (e.g., the presence of a target at an indicated potential area) is satisfied. In some embodiments, the availability of RAT-independent sensors at the radio node 200 is indicated to a network entity such as a SensMF or a configuration entity as capability information. A configuration associated with a conditional transmission configuration may subsequently be indicated to the second radio node 200.

An example of measurements which can be used in conjunction with RAT-independent measurements is a relative sum RSRPP of the paths for which the ToA and doppler shift is within an indicated range to the radio node 200 at a time instance T1 to the same measurements conducted at an earlier time TO. A condition can be determined from the measurement values by defining a threshold value, and the condition may be satisfied if the measured relative sum RSRPP value exceeds the threshold value. Additional examples of measurements include Rx-to-Tx and Tx-to-Rx time difference of a path, and AoA/ZoA differences of a path.

The second signal 230 may be a carrier wave to excite a tag, or a paging signal to page a UE potentially attached to the target. For example, the second signal 230 may be a sensing signal or reference signal for sensing measurement of another radio node, a physical data, control or paging channel for communicating with a radio device associated with a target location or object 240, a carrier wave for exciting an RFID tag, etc.

In some embodiments the second signal 230 may be a carrier wave for a backscattering tag or device (an ambient IoT device). In some embodiments, upon detection of the target being present, transmission of the second signal 230 is performed to read a possible backscattering device associated with the detected target. In some embodiments, the second signal 230 is a paging signal, intended to page a UE, in case the detected target is attached to a UE which can be paged by the wireless network.

A radio node 200 may transmit additional carrier waves or sensing signals based on detection of a tag. In an embodiment, the received first sensing signal 220 contains backscattering of a backscattering device and the determination of parameters of the second signal 230 is based on detection of the backscattering device.

In some embodiments, the received first signal 220 may contain backscattering of a backscattering device, wherein the radio node 200 may detect and/or measure and/or read information contained in the backscattering of the device. For example, a condition may be determined based on the backscattered data or measurements, and in particular, based on the presence of a backscattering device or the presence of a particular backscattering device with a known device ID or device group or type. As such, the transmission of a second signal 230 may be as another carrier wave/signal, as a sensing signal to facilitate sensing measurement by another node, or transmission of physical data/control/paging information to the device.

In embodiments of the present disclosure, the examples of a configured determination, adjustments of transmission of a second signal 230 by a radio node 200 (as the recipient of the first sensing signal 220 and the node performing adjustment of a configured second sensing signal) may apply to a second radio node 200 performing reception of a signal and measurements associated with the signal. A second radio node 200 may determine to perform reception and an indicated measurement on a sensing signal when an indicated condition criteria is met, or perform reception of the signal based on the adjustments to the determined measurement values of a first sensing signal 220, e.g., adjusting the Rx beam to a detected path/target beam/direction based on the first signal. Hence, the examples of determining transmission of a configured second signal 230 may describe similar determinations (based on measurement of the first signal 220) on reception and/or measurement of signals by another radio node 200.

In some embodiments, any of the configurations (of the first and second signals, the sensing signals, sensing transmission, sensing reception, sensing measurements or the associated parameters) and/or indications and/or reporting information elements between any of the radio node 200, the sensing transmitters, sensing receivers, the network entity or a subset thereof may be: received by the radio nodes 200; transmitted by the radio nodes 200; received by sensing Rx nodes; transmitted by sensing Rx nodes; received by sensing Tx nodes; transmitted by sensing Tx nodes; transmitted and/or received by a SensMF node; or any combination thereof:
1) via an UL, DL or SL physical data and/or control channel defined within the communication network, e.g., NR physical broadcast channel (PBCH), PDSCH, PDCCH, physical uplink shared channel (PUSCH), physical uplink control channel (PUCCH), physical sidelink broadcast channel (PSBCH), physical sidelink control channel (PSCCH), physical uplink shared channel (PSSCH), via higher layer (MAC-CE or RRC) signaling, wherein the radio node 200 and/or sensing Rx and/or the sensing Tx node is a UE;
2) via a logical interface between a sensing function (SF) and sensing nodes, as part of the LTE positioning protocol (LPP) or as modified/enhanced LPP message framework for sensing or as an interface defined for sensing message exchanges over an N1 interface between the SF and a UE, wherein the radio node 200 and/or sensing Tx and/or sensing Rx node is a UE;
3) via a logical interface between the SensMF and the Sensing nodes, as part of the new radio positioning protocol (NRPPa) (or a modified or enhanced NRPPa message framework for sensing) or as an interface defined over the next generation application protocol (NGAP) interface, wherein the sensing Tx and/or sensing Rx node is a TRP of the RAN and the SensMF is a core network function (SF, location management function (LMF), etc); or
4) via a logical interface between the SensMF and the Sensing Tx/Rx nodes wherein the SensMF is a serving gNB of a sensing task and the sensing node is a UE or a TRP of RAN. In some examples, the interface utilizes (at least in part) the X2 interface between a gNB of a sensing node and a serving or head gNB of a sensing task or a RAN logical entity for the sensing operation.

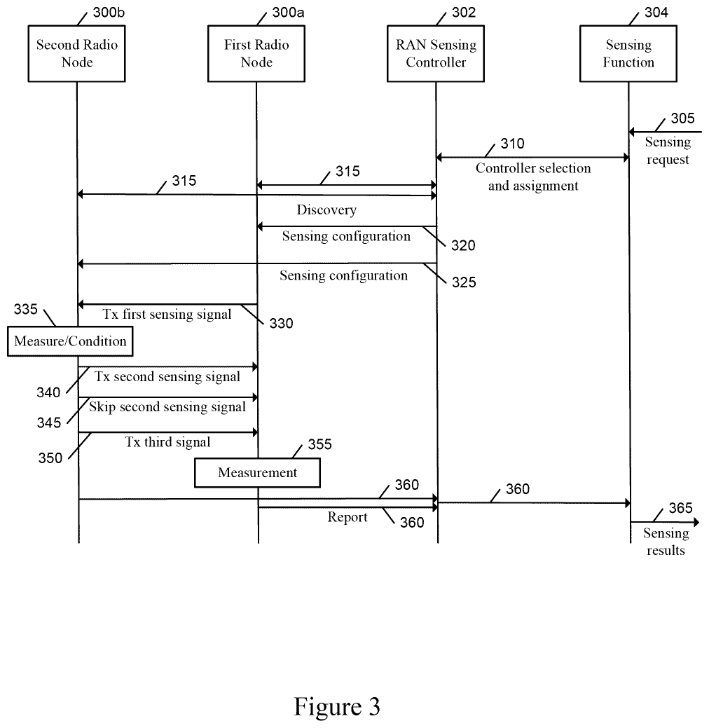

FIG. 3 illustrates an example of a signal diagram in accordance with aspects of the present disclosure. In particular, FIG. 3 illustrates an example procedure for round trip time or doppler measurement of a reflective path with conditional transmission of a second signal 230, e.g., a sensing signal.

Embodiments of the present disclosure relate to round trip and doppler measurements of a path. According to some embodiments, upon reception of a sensing task or information request from a sensing service/information consumer (which may include a description of expected target features, target type, area of interest for sensing of the target, sensing KPIs, etc.), a gNB or a logical RAN entity may be discovered and/or assigned (e.g., by a SF, a sensing-dedicated network function or enhanced LMF with sensing capabilities) to act as a sensing controller entity 302 (e.g., a RAN sensing controller) of the sensing operation to accomplish the sensing task (e.g., as a serving gNB of a sensing task or as a selected RAN controller entity for the sensing task). As such, the sensing controller entity 302 may identify at least two radio nodes 300 for the purpose of sensing, performing one or more of sensing signal transmission, sensing signal reception, measurement, and processing, and reporting the obtained sensing information, at least including a first radio node 300a and a second radio node 300b.

In FIG. 3, a sensing function or sensing function 304 (e.g., a network entity) communicates with a sensing controller entity 302 (e.g., a network entity), which communicates with a first radio node 300a and a second radio node 300b. Examples of radio nodes 300 may include one or more of a gNB, gNB centralized units or distributed units (CU/DU), RRHs, TRPs and/or UEs, e.g., one or more of pedestrian UE, vehicle UE, RSUs, areal UE etc. The radio nodes 300 may correspond to radio nodes 200 in FIG. 2.

At 305, sensing function 304 receives a sensing service, task or information request, which may include a potential target area, target description or type, required sensing service KPIs, etc. Sensing function 304 is exemplified as the core network entity controlling a sensing operation.

Selection of the sensing controller entity 302 and assigning the sensing task to the selected entities by the SF 304 is performed at 310. In some examples, this may include a request to act as controller of a sensing task by the SF 304 and a response by the sensing controller entity 302 for acceptance for acting as a controller of the requested sensing operation. The sensing controller entity 302 may be a gNB, gNB-CU, gNB-DU, or a logical entity acting as controller of the sensing operation. The SF 304 and/or the sensing controller entity 302 may perform as separate or combined entities for controlling sensing activities in a sensing network architecture.

Discovery and/or selection of radio nodes 300 by the sensing controller entity 302 is performed at 315. In some examples, this includes request (by the sensing controller 302) and response (by the radio nodes 300) of the expected sensing operation, which may include sensing transmission, sensing reception, measurement etc.

Configuration of the first node 300a for a sensing operation, comprising one or more of transmission of a first sensing signal, reception of a second sensing signal, performing measurements based on the received second sensing signal, and reporting a configuration for one or more of sensing measurement values to the sensing controller entity 302 is performed at 320. A first and/or second sensing signal may be configured as a single signal instance, as multiple signal instances (e.g., a positioning reference signal (PRS) set, multiple PRS sets, a configured reference signal (RS) with defined time/frequency resources wherein each instance is generated via a shift of one or more of symbols, slot, subframe, according to the NR frame timing), as a periodic signal with instances repeated at configured time shift/intervals, or as a semi-persistently scheduled signal. The sensing signal configuration may comprise parameters defining any of sensing-dedicated RS, PRS, CSI-RS, physical data/control channels, etc.

The configuration of the first node 300a at 320 may further comprise desired sensing measurements to be performed, based on the received second sensing signal, or detection of the presence or absence of the first signal transmission and interpretation of measurements performed by the second radio node 300b. In one example, based on the detection of the presence of the second sensing signal at 340 (which may correspond to the second signal 230) in the configured resources (e.g., according to a threshold of a measured RSRP of the second signal resources, wherein the threshold may be indicated by the sensing controller entity 302, or determined by the first node 300a based on one or more of the previously measured RSRP of the first signal, the transmission power of the second signal, an indicated value from the sensing controller entity 302, or a combination thereof), the first node 300a determines that a target is not present from the observation of the second radio node 300b.

Based on this determination, the first radio node 300a may be configured to: 1) increase the transmission power of the one or multiple N instances of a sensing signal (e.g., N as indicated by the sensing controller 302), when the sensing signal is transmitted for multiple instances (e.g., at multiple configured time instances, semi-persistently, periodically), 2) skip the transmission of one or multiple N instances of the sensing signal (e.g., N as indicated by the controller), 3) decrease the transmission power of the one or multiple N instances of the sensing signal (e.g., N as indicated by the controller), and/or 4) report to the sensing controller entity 302 the presence of a target.

At 325, the sensing controller entity 302 performs configuration of second node 300b for a sensing operation. The configuration may comprise one or more of transmission of a second sensing signal, reception of a first sensing signal, performing measurements based on the received second sensing signal, a condition to be determined by the second node 300b based on the received first sensing signal and/or the obtained sensing measurements (as discussed above) and reporting configuration for one or more of sensing measurement quantities to the sensing controller entity 302. In some embodiments, the transmission parameters of the second sensing signal are determined based on a determined condition at the second radio node 300b, as discussed above.

In some embodiments, when the transmission of the second sensing signal is configured to include adjustments to the obtained measurements (e.g., a Tx beam to be utilized according to the best Rx beam for reception of the path associated with the detected sensing target) the adjustment is maintained for the next transmission instance of the second sensing signal instance, the next M transmission instances of the second sensing signal instances, or all instances of the second sensing signal transmissions until the next instance of the first sensing signal is received and/or a detected condition or measurement based on the received future instances of the first sensing signal is changed.

In some examples, upon satisfaction of a configured condition (e.g., when a path or target is detected to be present), based on the reception of the N-th instance of the first signal, one or more (e.g., M) instances of the second sensing signals are transmitted subsequent to the instance of the first sensing signal by which the condition is satisfied.

In some other examples, upon determining the configured condition is not satisfied (e.g., when a path or target is determined not to be present), based on the reception of the N-th instance of the first signal, one or more instances of transmitting the second sensing signals are skipped subsequent to the instance of the first sensing signal by which the condition is determined to be not satisfied. In some examples, the skipped transmission instances of the second sensing signal are replaced by transmission of another signal such as another RS or a physical data or control channel, according to the configuration received by the second radio node.

At 330, the first radio node 300a transmits the first sensing signal, as configured by the sensing controller entity 302 and/or according to the self-determined configurations.

At 335, the second radio node 300b determines whether a condition is satisfied and/or performs measurements based on reception of the one or more of the first sensing signal instances, as configured by the sensing controller entity 302 and/or according to a self-determined configuration.

At 340, the second radio node 300b transmits a second sensing signal, or skips an instance (does not transmit) of the second sensing signal at 345. Transmission and/or adjustment or skipping of one or more instances of the second sensing signal may be performed as configured by the sensing controller entity 302 and/or according to determined configurations.

The second radio node 300b may transmit a third sensing signal at 350. Either or both of the second and third sensing signals 345 and 350 may be received by the first radio node 300a.

At 355, the first radio node 300a measures one or both of the second and third sensing signals based on the one or more second sensing signal instances, as configured by the sensing controller entity 302 and/or according to the self-determined configurations.

At 360, results from measurements performed by one or both of the first radio node 300a and the second radio node 300b are reported to the sensing controller entity 302, which in turn reports associated information to the sensing function 304. The data reported by the sensing controller entity 302 may comprise measurement data, information indicating whether conditions are satisfied, and additional information such as how measurements were performed, sensing parameters, sensing equipment, etc.

Information related to the sensing results is then provided by the sensing function 304 to one or more requesting entity at 365.

In some embodiments, a sensing operation is performed by two or more second radio nodes 300b as a conditional group multi-round trip time (RTT) or round trip doppler (RTD) sensing operation, for example. In an embodiment, configuration of the first sensing signal and/or at least part of a condition to be determined is shared among the plurality of second radio nodes 300b (e.g., the target description and/or area of interest may be indicated via a group common signaling to the second radio nodes 300b). Two second sensing signals transmitted by different radio nodes may be multiplexed in the time domain, where the two signals are assigned with different time resources or shifted with different time duration, or in the frequency domain, where the two signals are assigned with different frequency resources or shifted with different time durations, or in the code domain, where the two signals are assigned with different codes or sequences for transmission.

In some embodiments, a plurality of second radio nodes 300b are configured to react differently to a determined condition, based on reception (measurement) of the first sensing signal. In some examples, when a target is not detected at a second radio node #1, based on the reception of the first sensing signal, the second radio node #1 is configured to skip transmission of the second sensing signal, but a second radio node #2 is configured to transmit the second sensing signal with a wide beam and/or with a higher transmission power. The wide beam and higher transmission power may be indicated to the second radio nodes 300b. As such, the first radio node 300a may continue to receive and perform sensing measurements based on the received second sensing signal of the second radio node #2, while detecting or receiving an indication of the lack of transmission of the second radio node #1 as additional information.

Accordingly, in some embodiments, multiple second radio nodes 300b may react differently to the condition of detecting or not detecting a target. In addition, a network entity (e.g., SF 304) may assign different criteria or adjustment configurations to different second nodes 300b of a group of multi-RTT or RTD measurements.

In some such embodiments, the first node 300a measurement quantities may be determined based on jointly determining or measuring the received second sensing signals (of their received RSRP, RSRPP of one or more paths associated to the sensing target, ToA, AoA, of the detected target path, etc.), the total received energy of the second sensing signals, number of detected transmissions by the second sensing nodes 300b. Accordingly, a first node 300a may measure values jointly based on the received sensing signals of multiple nodes and detected or indicated determinations.

In some embodiments, such as when the first node 300a is a TRP and a second node 300b is a UE, the first sensing signal may be a DL RS (e.g., a DL PRS) and transmitted according to a time/frequency reference of the DL frame. In some embodiments, such as when the first node 300a is a UE and a second node 300b is a UE, then the first sensing signal may be a SL RS (e.g., a SL PRS) and transmitted according to a time/frequency reference of the one of a DL frame, UL frame, or SL frame.

In some embodiments, such as when the first node 300a is a TRP and a second node 300b is a TRP, then the first sensing signal may be a DL RS (e.g., a DL PRS) and transmitted according to the time/frequency reference of the DL frame, or an RS transmitted in a TRP2TRP direction (not intended to be decoded by a UE, and according to an indicated or agreed time-frequency reference between the Tx and Rx TRPs, e.g., according to the DL or UL frame of the first radio node TRP, DL or UL frame of the second radio node, with an indicated/adjusted TA/delay by the first radio node).

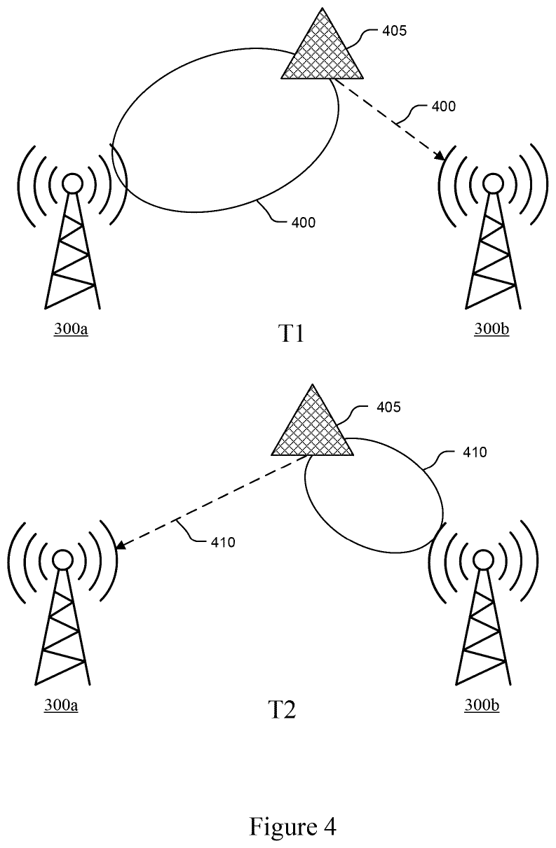

FIG. 4 illustrates an example of a RTT or RTD measurement process without sensing-based transmission configuration adjustments. At time T1, the first radio node 300a transmits a first sensing signal 400 which may be a wide beam signal to a target 405, and the first sensing signal 400 reflects off the target 405 and is received by the second radio node 300b, which measures the time at which the signal is received. Subsequently, at a later time T2, the second radio node 300b transmits a second sensing signal 410 which may be a wide beam signal to a target 405, and the second sensing signal 410 reflects off the target 405 and is received by the first radio node 300a, which measures the time at which the signal is received. In an embodiment, the second signal 410 may be transmitted with transmission parameters regardless of the outcome of the sensing measurements of the first signal 400 by the second node 300b.

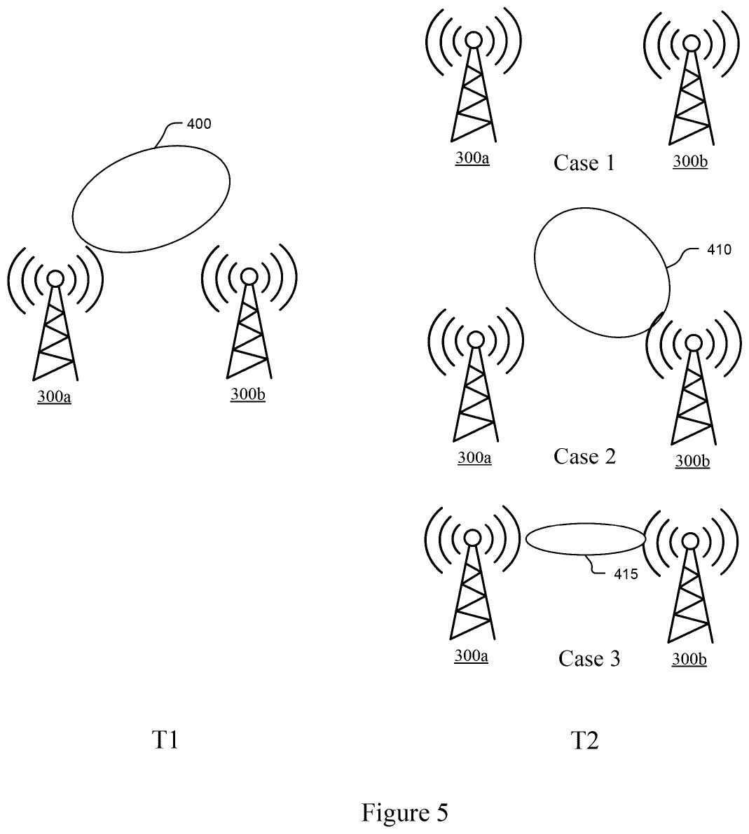

FIG. 5 illustrates an example of an RTT or RTD measurement process using transmission parameter adjustments when a condition is not satisfied. In FIG. 5, the condition is that the target 405 is not present.

In particular, FIG. 5 depicts situations where the transmission of the second signal 410 from the second node 300b is, at least in part, determined based on the outcome of sensing measurements performed by the second node 300b on the first signal 400. The measurement performed by the second node 300b is measuring the first signal 400, and the outcome of that measurement may be detecting no energy at time and frequency resources associated with the first signal 400 or detecting energy below a threshold value.

In the three cases illustrated in FIG. 5, the second radio node 300b determines that a configured condition is not satisfied (e.g., a target 405 is not present in an indicated potential area, RSRPP of a new paths within an indicated delay or angle range are less than an indicated threshold, etc.). As such, the second radio node 300b determines transmission parameters of the second signal 410 based on the determination of the condition.

In Case 1, the transmission of the second signal 410 is skipped by the second radio node 300b when the target 405 is determined to be not present or the effectiveness of the transmission by the second radio node is determined to be less than a threshold value. In one example, the second node 300b, based on a collected RSRPP being less than a threshold value from paths relevant to sensing the intended target 405, does not participate in the second signal transmission. In this example, nodes with better observability of the target 405 may transmit a second signal 410.

In Case 2, the second radio node 300b uses a wider beam for transmitting second signal 410 in order to provide illumination of the potential sensing area at a larger sensing area. In another embodiment, second radio node 300b may transmit a beam that is displaced relative to an initial sensing area to cover other potential sensing areas to be sensed by the first node 300a. Embodiments of Case 2 may enable sensing of targets 405 which are not within the area illuminated by the first signal 400, but may be illuminated and become measurable when a wider beam or a displaced beam is transmitted by second node 300b to enable sensing of an expanded sensing area by the first radio node 300a.

In Case 3, the second radio node 300b determines that the indicated condition is not satisfied (e.g., no new path or group of new paths is observed at an indicated delay or angle margin with an RSRPP greater than a threshold value). Accordingly, the second radio node 300b transmits a different signal other than the configured second sensing signal 410, e.g., a signal 415 in a physical data or control channel, and a second set of transmission parameters (e.g., beam, transmission power, etc.) may be used to transmit the signal 415.

In one example, the signal 415 comprises a physical channel containing data or control information which is transmitted according to the configured transmission parameters. In some examples, the physical channel contains information not necessarily related to the conducted sensing measurements by the radio node. In some other examples, the physical channel contains information of the conducted sensing measurements (e.g., measurements based on previous instances of the first signal, when first signal is a periodic sensing signal, or RAT-independent sensing data obtained by the radio node). In some examples, some of the measured/determined sensing-related data are transmitted by the radio node according to a configured transmission for reporting of the measurement, but some other quantities may be reported via the physical channel when the condition is determined to be not present/true.

One such example includes the radio node determines presence and location of a target based on measurement of plurality of power measurements at different AoA, ZoA, ToA, doppler shift, etc. conditions and/or based on a camera data, and (in addition to transmission and adjustment of the second sensing signal as described above to facilitate further sensing measurements on the sensing target) reports the presence and location and/or measurement of a subset of the paths according to a configured reporting configuration, when the target is detected to be present. Moreover, when the target is detected to be not present, the radio node (instead of performing transmission of the second sensing signal) transmits further details of the obtained sensing measurement/data, e.g., transmitting the obtained camera data/pictures with high resolution, or transmitting the obtained power measurements at all or plurality of the AoA, ZoA, ToA, doppler shift with more details.

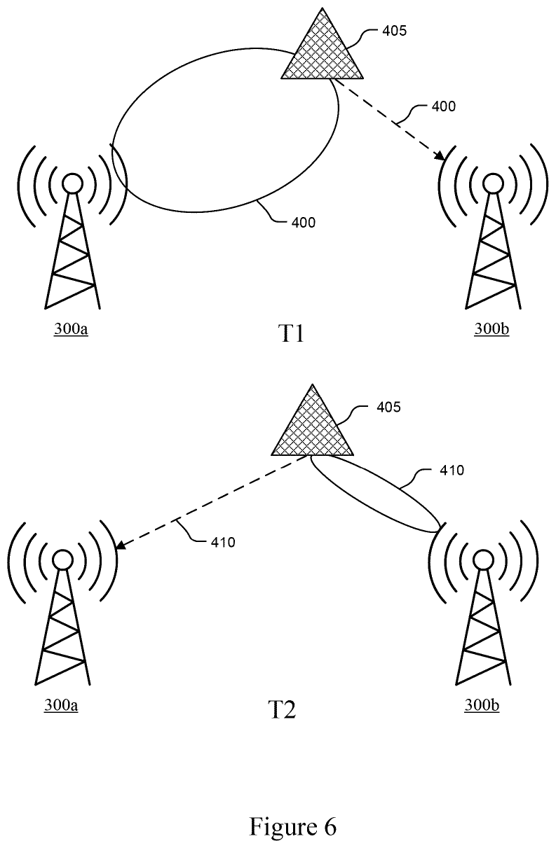

FIG. 6 illustrates an example of an RTT or RTD measurement process with sensing-based Tx configuration adjustments when a condition is satisfied.

In an embodiment, as depicted by FIG. 6, upon determination that a condition is satisfied (a target 405 is detected), the transmission parameters of the second signal 410 are adjusted based on the obtained measurements of the first signal 400. For example, the transmission beam may be chosen according to the detected path, AoA, and/or ZoA associated to the detected path or target 405. The second node 300b may determine that the condition is satisfied according to a sum RSRPP of all or newly appeared or detected paths within an indicated angle or delay range exceeding an indicated threshold value. In the embodiment of FIG. 6, the transmission parameters of the second signal 410 may be adjusted to be directed to the target 405.

Embodiments of the present disclosure relate to conditional multiplexing of a data or control channel. In such embodiments, a configured transmission of a third signal by a second radio node 300b over indicated resources which are shared with transmission configuration of a second signal is multiplexed with the transmission of the second signal, according to the determination of the second radio node 300b (e.g., of a condition such as detection of a sensing target or path within an indicated expected area/angle range) based on measurement of the first signal by the second radio node. The third signal may be the signal transmitted at 350 in FIG. 3, and may be a physical data/control/paging channel or a third sensing signal. The resources may be shared in at least one symbol or resource element. The second signal may be a PRS, or a sensing dedicated RS as the second sensing signal, or a physical data/control channel to be conditionally transmitted by the second radio node 300b.

When an indicated condition is determined to be true (or, in some alternate embodiments, to be not true) by the second radio node 300b, the second radio node 300b transmits the second signal (and potentially, with adjustments of the transmission parameters of Tx power, Tx beam, etc. to the obtained measurement quantities of the first sensing signal), and when the condition is determined to be not true (or, in some alternate embodiments, to be true), the second radio node 300b transmits the third signal at least in part at the shared resource.

Multiplexing variations of physical channel and sensing signal transmissions may be performed when a target is detected, multiplexing the transmission of multiple sensing signals and physical channels according to an a priori configuration. Variations include only transmitting one signal, transmitting both signals, and applying parameter adjustments.

In some embodiments, when one or more is determined to be true then, within the set of time/frequency resources, the second radio node 300b may skip transmission of the third signal and transmit the second sensing signal according to the received transmission configuration and/or with adjustments of the transmission parameters to the sensing measurement quantities (e.g., transmission of the second sensing signal with a beam associated to the detected path corresponding to the sensing target, e.g., variations of transmission parameters as described above). In some embodiments, the transmission of the physical data/control/paging channel is rate matched around the time/frequency resources, where the transmission of the second sensing signal has been conducted (and transmission of the physical data/control/paging channel has been skipped).

In some embodiments, when one or more is determined to be true then, within the set of time/frequency resources, the second radio node 300b may transmit the third signal on a physical data/control/paging channel (within the time/frequency resources and according to the configured parameters for the transmission of the physical data/control/paging channel) jointly with transmission of the second sensing signal according to a received transmission configuration and/or with adjustments of the transmission parameters to sensing measurement values.

In some embodiments, a third radio node 300, which may act as the receiver of the physical data/control/paging channel, is indicated with the time/frequency resources and the second sensing signal (description/parameters defining a sensing signal, e.g., PRS, SRS, sensing-dedicated RS). The third radio node may determine, based on an explicit indication from the second radio node 300b or implicitly based on reception at the time/frequency resources, whether the second sensing signal is transmitted by the second radio node 300b (e.g., by measuring the RSRP value of the transmitted second sensing signal and comparing the measured value to a threshold) and subsequently perform successive cancellation of the received second sensing signal, before decoding the physical data/control/paging channel. In some embodiments, the third radio node 300 is the same node as the first radio node 300a. In some other embodiments, the third radio node is a different node from the first node 300a.

In some embodiments, when one or more condition is determined to be true, within the set of time/frequency resources, the second radio node 300b skips transmission of the second sensing signal and transmits the third signal containing a physical data/control/paging channel at the indicated time/frequency resources, e.g., according to an a priori transmission parameters and/or according to parameters adjusted to a detected target, e.g., using a beam directed towards the detected target.

In some embodiments, when a condition is determined to be not true (e.g., the target is not present) then, within the set of time/frequency resources, the second radio node either 1) skips transmission of the second sensing signal and transmits the physical data/control channel at the indicated time/frequency resources, or 2) skips transmission of the physical data/control/paging channel within the time/frequency resources and transmits a second sensing signal according to a received transmission configuration and/or with adjustments of the transmission parameters based on sensing measurement values (e.g., transmission of the second sensing signal with a wider beam to enable sensing of a larger potential sensing area by the first radio node as seen in Case 2 of FIG. 5).

In some embodiments, a configured determination or adjustment of a transmission of one or more of a second signal and a third signal is performed only if both the second and third signal are configured for transmission within a shared resource. In one example, a first determination or adjustment (e.g., including an adjustment/determination configuration and an indication of measurement values for such determination/adjustments) for transmission of a second signal is performed by the second radio node 300b only when the third signal is configured for transmission at least in part at resources shared with the second signal, and a second determination or adjustment for the transmission of a second signal is performed by the second radio node 300b in the absence of a third signal transmission configured at least in part on the shared resources to the second signal. In one such example, a configured sensing signal is transmitted regardless of whether a target is detected when there is no other physical channel or sensing signal configured for transmission at configured resources of the sensing signal, but when the second radio node 300b is simultaneously configured further with transmission of a physical channel and/or another sensing signal, then the second sensing signal may be skipped upon determining the target is not present.

Embodiments of the present disclosure relate to sensing-based conditional beam management. In such an embodiment, a second radio node 300b may be configured with the transmission of a physical data/control/paging channel over a set of time-frequency resources, and one or more of the parameters for transmission of the physical data/control/paging channel may be determined by the second radio node 300b according to determined sensing measurement values and/or a condition based on the reception of a first signal as discussed above. In some embodiments, a third radio node 300 receives the physical channel, at least in part, according to the transmission parameters of the physical channel employed by the second radio node. The third radio node 300 may be a receiver node of the physical data/control/paging channel, and may be the same node as the first radio node 300a or a different radio node.

When a condition is determined to be true (e.g., a target or path is detected to be present by the second radio node 300b within an indicated power, delay, angle or doppler range), a Tx beam is chosen based on one or more criteria.

In some embodiments, the Tx beam for transmission of the physical channel is chosen with association to the detected target or path direction/angle. For example, the Tx beam may be chosen to maximize illumination of the target, e.g., the Tx beam is chosen by the second radio node with a quasi-co location (QCL) relationship with the best Rx beam utilized for reception of the detected target/path and/or a QCL relation with the detected path or target. To establish a QCL relationship, a radio node may select a Tx beam which corresponds to a received beam. In an embodiment, the Tx beam corresponds to the received beam when the beamwidth, e.g., a half-power beamwidth, of the beam encompasses one or both of an angle or azimuth at which the received beam was received.

In some embodiments, the Tx beam for transmission of the physical channel is chosen to avoid illumination of the detected path/target. In an example, the beamwidth of the Tx beam may be selected so that the detected target/path is not within a half-power beamwidth of the Tx beam.

In some embodiments, the Tx beam for transmission of the physical channel is chosen regardless of the detected target (e.g., as a previously indicated or determined beam for Tx of the physical channel).

The Tx beam for transmission of the physical channel (and potentially Tx parameters associated to the Tx beam including one or more of timing advance (TA), resources associated with the first Tx, demodulation reference signal (DMRS) configuration, rate matching of the physical channel etc.) for transmission of the physical channel may be chosen according to an a priori indicated or determined beam/parameter set, wherein the first a priori indicated or determined beam is chosen when a condition is not satisfied and the second a priori indicated or determined beam is chosen when the condition is satisfied. In one such embodiment, the second radio node 300b is a UE and is configured for transmission of the physical channel in the UL direction via two possible UL beams (e.g., wherein each UL beam is associated to a separate TRP and the transmission of each beam is further associated with a different set of one or more of TA values, time-frequency resources for transmission, DMRS type/density, or a combination thereof).

Furthermore, according to some aspects of the one such embodiment, the condition comprises detection of paths or targets at a potential sensing area or an angle or delay range associated with the UL transmission of the physical channel via the first beam (e.g., for detection of a moving object in the direction related to the first beam blockage). As such, once the second radio node 300b detects that the condition is satisfied (e.g., the first indicated beam will be potentially blocked based on the obtained sensing measurements of the first signal), the second radio node may use the second indicated or determined beam and, in some examples, the associated TA, DMRS type/density, communication resources, etc. associated with the second transmission beam (e.g., where the second beam is associated with transmission to the second TRP).

In some embodiments, one or more Tx beam for transmission of the physical channel is determined as a best communication beam for the physical channel, among the group of pre-determined candidate beams for the physical channel (e.g., a set of 5 beams determined at the second radio node 300b to be the best beams for transmission of the physical channel), with one or both of 1) a maximum illumination level towards the target (e.g., the best available communication Tx beam for which a path associated with the target is observable from a similar QCLed Rx beam with at least RSRPP above an indicated threshold based on the received first signal), or 2) a minimum illumination level towards the target (e.g., the best available communication Tx beam for which the path associated with the target is observable from a similar QCLed Rx beam with an RSRPP below an indicated threshold based on the received first signal).

In some embodiments, the Tx beam for transmission of the physical channel is determined as a combination of two beams as discussed above. For example, the first beam may be associated with the best communication beam for a physical channel and the second beam may be associated with the beam for illuminating the target (e.g., as a beam with a highest RSRPP associated to a detected path to the target). In some examples, the second beam appears as a side-lobe for the main beam (e.g., first beam) wherein the sidelobe serves to constantly illuminate the potential sensing area of interest or the detected sensing target (e.g., for tracking of the target).

In some such embodiments, the combination of the two beams may be communicated as an indication via a QCL (e.g., type-D) relation of the Tx beam jointly to the first beam and the second beam. In some such embodiments, the joint QCL relationship may further comprise an energy split between the two beams (e.g., by assigning 10% of the energy to the sidelobe/beam associated with the target and 90% of the energy to the main lobe for the beam associated with best selected beam for communication of the physical channel).

The DMRS configuration of the physical channel transmission may be a DMRS configuration corresponding to the condition being detected and/or adjusted or updated (e.g., to an a priori DMRS configuration associated to a determined condition and/or the determined Tx beam configuration).

The Tx power of the physical channel may be adjusted according to the detected condition. For example, the Tx power of the physical channel may be scaled according to an observed RSRPP of the detected path or target, such that the target or path is illuminated with at least a minimum energy level. In some examples, the Tx power is determined as a scaled power of the transmission of the first signal or a known or indicated Tx power to the second radio node 300b with a determined or indicated scale to the second radio node 300b. In some embodiments, the scale (e.g., k) is determined at the second radio node 300b such that, when utilizing an Rx beam corresponding to the determined Tx beam for transmission of the physical channel, the measured RSRPP (e.g., P) associated to the detected path or target can be updated, with the same scale value, to satisfy an indicated or known threshold at the second radio node 300b, such that k=threshold/P.

In some embodiments, when a condition is determined to be not true (e.g., no target is detected, or no new path is detected with an RSRPP increase compared to a previous time instance of more than an indicated threshold), then a Tx beam (and, in some examples, further transmission parameters) for transmission of the physical channel may be determined to be the Tx beam (and, in some examples, the transmission parameters) as indicated to the second radio node 300b to be applied when the condition is not satisfied. In some examples, when the path or target is not detected to be present by the second radio node 300b, the best Tx beam for the physical channel as determined before is applied by the second radio node 300b.

In some embodiments, a receiving node is notified of transmission parameters of a physical channel transmission. The third node 300, which may be the same node as first node 300a or a different node, may receive transmissions in a physical data/control/paging channel.

In an embodiment, the third node 300 is informed, via an indication reported from the second node 300b of the transmission of the second sensing signal (e.g., that the second sensing signal is transmitted at an indicated resource) and/or transmission parameters of the second sensing signal (e.g., time, frequency, transmission beam information, transmission power of the second sensing signal, parameters defining the second sensing signal, e.g., CSI-RS ID etc.). In some such embodiments, the third node 300 is further indicated with performing interference cancellation due to the transmission of the second sensing signal, e.g., estimating the received second sensing signal and subtracting it before performing further receptions (e.g., of other physical data/control channels). In some such embodiments, the third node is further indicated with the Rx beam information for reception or avoiding the second sensing signal.

In an embodiment, the third node 300 is not configured or informed by the second radio node 300b or a configuration node, but blindly detects the transmission of the second sensing signal (e.g., that the second sensing signal is transmitted at an indicated time-freq. resource by correlating the received signal with the transmitted known second sensing signal or comparing the RSRP of the received second sensing signal with a threshold) and/or the transmission parameters of the second sensing signal (the transmission beam information, transmission power of the second sensing signal, parameters defining the second sensing signal, e.g., CSI-RS ID etc.).

In some such embodiments, upon detection by the third node 300, or in some embodiments, not detecting the transmission of the second sensing signal, one or more of the Rx beam for reception of the second sensing signal, Rx beam for reception of another signal (e.g., a physical data channel), and Rx beam for cancelling the second sensing signal, transmission parameters of the second sensing signal, the presence and/or transmission parameters of another physical channel, can be assumed by the third node based on an a priori received configuration or indication (e.g., by a configuration node or by the second radio node 300b). In one such example, the third node 300 detects that the second sensing signal has not been transmitted at an indicated time-frequency resource, and hence the third node assumes a previously indicated Rx beam for reception of a physical data channel when the second sensing signal is not present.

In an embodiment, the third node 300 is informed, via an indication in a report from the second node 300b of the transmission of the physical channel (e.g., that the physical channel is transmitted at an indicated time-freq. resource) and/or transmission parameters of the physical channel (the transmission beam information, transmission power of the second sensing signal, parameters defining the second sensing signal, e.g., CSI-RS ID etc.). In some such embodiments, the third radio node 300 determines autonomously or is further indicated (e.g., by the second radio node 300b and/or a configuration node) of the Rx beam and/or other reception parameters for reception of the physical channel. In some examples, the Rx beam of the third node is assumed to be on or more of an a priori indicated beam for reception of the physical channel, and an Rx beam associated with a sensing target or path associated with a sensing target or an indicated sensing target area.

In an embodiment, the third node 300 is not indicated or informed by the second radio node 300b or a configuration node of the transmission of the physical channel, but blindly detects the transmission of the physical channel (e.g., detects that that the physical channel is transmitted at an indicated time-freq. resource) and/or the transmission parameters of the physical channel (transmission beam information, transmission power of the second sensing signal, etc.). In some such embodiments, subsequent to the third node determining transmission of the physical channel, the third radio node determines autonomously or is indicated (e.g., by the second radio node 300b) of the Rx beam and/or other reception parameters for reception of the physical channel (e.g., the Rx beam as a default or as indicated before, an Rx beam as a beam associated with the detected target or the target area).

In some embodiments, a receiver node is notified of second sensing signal parameters. For example, a fourth node 300 may be the recipient of the second sensing signal. The fourth node may be the first node or the third node, for example. The fourth node 300 may be informed with an indication one or more of 1) a determined condition at the second radio node (e.g., a target is detected); 2) the transmission of the second sensing signal by the second radio node (e.g., a second sensing signal is transmitted); 3) all or a subset of the transmission parameters utilized by the second radio node 300b for transmission of the second sensing signal (the Tx beam at the second radio node, the Tx power, DMRS configuration etc.); and 4) the Rx beam or further reception parameters to be employed by the fourth node for reception of the transmitted second sensing signal.

In some embodiments, the capability of the second node 300b for sensing measurements, determination of a condition based on sensing measurement of the first signal, adjustment of the one or more transmission parameters to the performed sensing measurement or condition determination, may be indicated by the second radio node to a sensing controller entity 302 and/or SF 304. The configurations associated with a conditional transmission configuration may then be indicated to the second radio node 300b subsequent to the capability indication step.

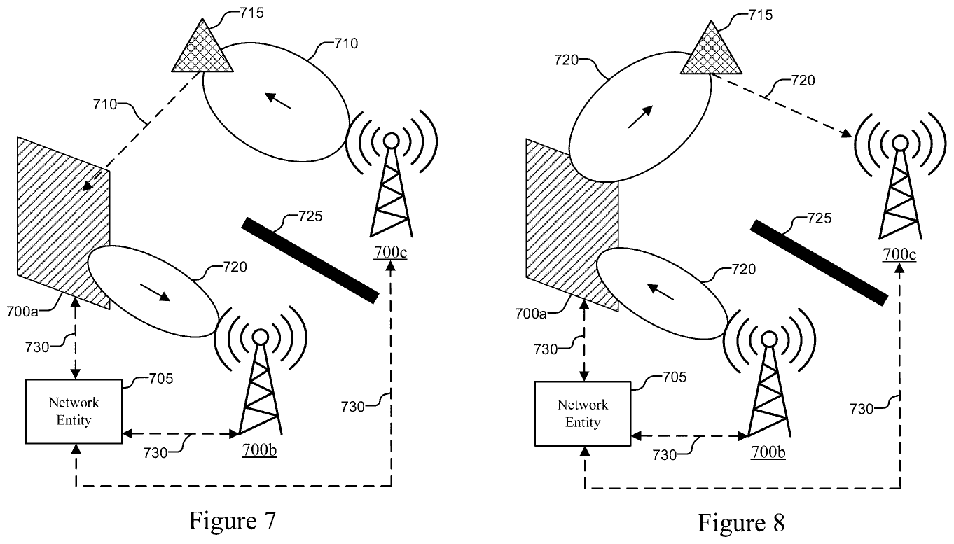

FIGS. 7 and 8 illustrate examples of sensing operations of three nodes in accordance with aspects of the present disclosure.

Three nodes 700a, 700b and 700c are present in FIG. 7. Node 700c transmits a sensing signal 710 towards an object 715. The sensing signal 710 reflects off the object 715 and arrives at node 700a. In some embodiments, the node 700c (as well as node 700b) may be a radio node such as radio nodes 200 and 300 discussed above. In the embodiment illustrated in FIG. 7, a node 700a may be capable of one or both of reflecting incident sensing signal 710 as sensing signal 720 towards node 700b, and actively transmitting signal 720 towards node 700b. Accordingly, node 700a may be, for example, a reconfigurable intelligent surface (RIS), a relay node, a wireless repeater, a network controlled repeater (NCR), a vehicle mounted relay (VMR), a wireless access backhaul (WAB), a Femto node, an integrated access backhaul (IAB) node, or a transceiver or reflecting device attached to or otherwise associated with a base station or UE.

While only one object 715 is shown in FIG. 7, multiple objects may be present in a radio path between node 700c and node 700a. For example, several buildings may be present in an urban corridor which reflect signals to provide a radio path between two nodes 700.

In the embodiment of FIG. 7, an obstruction 725 lies between node 700b and node 700c. The obstruction 725 may limit the ability of node 700b to wirelessly communicate directly with node 700c, and node 700a may facilitate communication between those nodes by receiving, transmitting and/or reflecting signals.

Also shown in FIG. 7 is a network entity 705 which communicates with nodes 700 through a backhaul 730. The backhaul may be an X2 interface, a similar physical connection interface, and/or may comprise one or more wireless portion. The network entity 705 may correspond to network entities described elsewhere in this disclosure, e.g., a network entity 102, 302 or 304. In specific embodiments, the network entity 705 may comprise a sensing controller or sensing function and may transmit a configuration comprising parameters and conditions for receiving, processing, measuring, transmitting or reflecting (which may comprise transmitting as noted above) signals to one or more of the nodes 700. In the examples below, the term reflection may refer to either passive reflection or active re-transmission of a received signal.

The configuration from network entity 705 may comprise one or more elements discussed elsewhere in this disclosure. In some embodiments, the configuration comprises a first set of one or more parameters for reception and measurement of sensing signals and a second set of one or more parameters for transmission of sensing signals, wherein at least one parameter of the first set of one or more parameters indicates a metric of the sensing signals for measurement, and wherein at least one parameter of the second set of one or more parameters indicates at least one condition for outputting sensing signals by transmitting or reflecting the sensing signals.

The configuration received by node 700a from network entity 705 may comprise one or more of parameters such as time and frequency parameters for receiving a first sensing signal 710. The configuration may further comprise a condition to be determined by the node 700a, at least in part based on measurements of one or more metric of the first sensing signal 710. One example of such a condition is the detection of a target (e.g., object 715) such as a UAV or similar vehicle, which may be accomplished by receiving the first sensing signal 710 within an indicated ZoA/AoA or target location range. Another example of a condition is the detection of a path, which may be determined by a path power value such as RSRPP being above a threshold value. The threshold value may be indicated to the node 700a, e.g., in the configuration from the network entity 705.

The configuration received by node 700a may comprise parameters for a first transmission or reflection configuration and a second transmission or reflection configuration. The parameters may include one or more of parameters for determining whether a condition is present, metrics for measurement of received signals, time and/or frequency resources for which the second configuration is applied, etc.

In some embodiments, the reflection configuration comprises at least one or more of an incidence AoA/ZoA/depth, a transmission or reflection ZoD/ZoD/depth, one or more reflection energy/power level/portion associated with an incidence/reflection pair, e.g., reflection from the incidence angle AoA/ZoA X to the reflection angle AoD/ZoD Y1 with P1 of the incidence/reflection energy and to the reflection angle AoD/ZoD Y2 with P2 of the incidence energy.

In some embodiments, based on the second reflection or transmission configuration, the node 700a may adopt, at least in part, an indicated reflection configuration. For example, the node 700a may adopt the first reflection configuration or a separately indicated or determined reflection configuration as a default second reflection configuration in all or a subset of the parameters. This may occur, for example, when a reflection or transmission of node 700a is intended to be received by a receiver node with a known or indicated node-to-receiver beam direction, or as another example, when the incidence angle of the node 700a is used as a default parameter from a known or indicated angle corresponding to a link between a transmitter node and node 700a. Other examples are possible.

In some embodiments, based on the second reflection or transmission configuration, the node 700a may assume one or more of the AoA/ZoA/depth of incidence of a second reflection configuration according to a measured AoA/ZoA/depth of incidence for a path or target.

In some embodiments, based on the second reflection or transmission configuration, the node 700a may assume one or more of the AoD/ZoD/depth of reflection of the second reflection configuration according to a measured AoD/ZoD/depth of reflection for a path or target.

In some embodiments, based on the second reflection or transmission configuration, the node 700a may assume a power ratio for reflection or transmission of the second signal according to measured energy associated with an incident or reflection angle/target/path.

For example, when a node 700a detects a target or path with an estimated angle based on a first signal, the node 700a may adopt a strategy for reflecting a second signal including reflecting a beam associated with the detected target or path 1) to a first beam/angle (e.g., associated with a first receiver device of the second sensing signal) with an energy ratio R1 and 2) to a second beam/angle (e.g., associated with a second receiver device of the second sensing signal) with an energy ratio R2. In some examples, the ratios R1 and R2 are configured for the node 700a. In some examples, the radio node is indicated with R1=R2=1, i.e., the reflected signal energy (as portion of the incident energy received/observed from the sensing target) are equally reflected towards the first receiver device and second receiver device. In some other examples, the R1=1, and R2=K and the K is indicated to the radio node e.g., in linear or dB scale and via an index from a codebook.

In some embodiments, the configuration for determining the second reflection strategy and/or a condition or measurement to be determined and/or a configuration for measurements of the node 700a based on the first sensing signal is received by the node 700a subsequent to a capability indication in an IE transmission by the node 700a of its capability to perform sensing and/or measure one or more metric associated with sensing, such as an RSRPP reading at an indicated AoA/ZoA/depth of arrival range.

Returning to FIG. 7, a node 700a may measure a sensing signal 710 (e.g., a first signal) at a first time instance and determine a condition based on measuring a metric of a sensing signal 710. The node 700a may determine parameters for reflecting a second signal 720 based on determining whether the condition is satisfied. In one such example, the node 700a measures an RSRPP or RSRP of paths corresponding to an indicated Rx beam (in FIG. 7, sensing signal 710) or an indicated range of AoA/ZoA, wherein a condition of the presence of a target in the angle or zenith range is determined by comparing the obtained RSRP or RSRPP measurement to a threshold value. In some such examples, the AoA/ZoA of the detected target or path may be further determined by the node 700a.

Subsequently, parameters for transmitting/reflecting a sensing signal 720 (e.g., a second signal), which may be valid at a second time instance after the first time instance, may be determined based on a determined condition such as the presence of a target or a measurement value (target AoA/ZoA). In particular, in FIG. 7, the beam 710 may be assumed to be in the direction of the detected target with respect to the node 700a or, in some examples, the Rx beam used for or associated with the detection of the condition or measurement value (e.g., at which the power is measured or via which the target presence is determined, the beam at which the higher power of the target is measured).

Accordingly, with respect to the signal directions shown in FIG. 7, the node 700a may determine whether a condition is satisfied at a first time instance based on measurements of the received sensing signal 710, and use the information, which may comprise information of the condition and/or information from the measurements, to adjust parameters for reflecting/transmitting the sensing signal 720. For example, when node 700a determines that a target is detected or a path is present, node 700a may continue to use parameters associated with that determination for subsequent instances of reflecting/transmitting a signal 720 to receiver node 700b.

In another embodiment, as seen in FIG. 8, node 700a may use parameters from the sensing operation of FIG. 7 for a sensing measurement process including node 700b and node 700c or communications from node 700b to node 700c. For example, when node 700a determines that a target or path is present by sensing operations discussed above, node 700a may use the same angle/zenith used to receive signal 710 at an earlier time instance as parameters for reflecting/transmitting a second signal 720 to node 700c. In particular, node 700a may use measured incidence metrics as transmission/reflection parameters, such that the second signal 720 is delivered/transmitted/reflected in the same direction at which signal 710 was received. In some embodiments, the second signal 720 may be a sensing signal, which may be used for sensing paths or targets, or a data or control signal which is used for communication between nodes 700b and 700c.

In some embodiments, upon explicit indication, or implicitly upon determination of a condition (e.g., a target being present), the node 700a may be configured to adopt a reflection configuration such that the reflection angle is determined according to an explicitly configured direction/beam.

In another embodiment, the node 700a may be configured to adopt a reflection configuration such that an incidence angle is considered to be all potential angles of incidence (all incoming waves to the node 700a to be reflected towards the reflection angle). In some such examples, all incoming waves are considered, for reflection/transmission, subject to an indicated permissibility condition (e.g., all incident wave other than the waves with an indicated incidence angle or angle range, e.g., excluding the AoI of 30-60 degrees according to the LCS of the node 700a). In some such examples, the reflection strategy of the node 700a is determined at the node 700a, with an indication of an optimization objective for the reflection strategy. In some embodiments, the optimization objective may comprise maximizing the total reflection energy (e.g., towards an indicated beam/angle), or minimizing the total reflection energy (e.g., towards an indicated beam/angle).

In some embodiments, the incident waves further comprise signals of different frequency bands for which node 700a is not explicitly configured and/or the frequency bands/carrier frequencies/component carriers other than the first signal 710 or the explicitly configured/indicated bands/frequencies. Accordingly, in some embodiments, the node 700a may consider all RF energy incident to the node when applying an objective of maximizing or minimizing energy to a certain direction, and not simply energy received from one particular node.

In some embodiments, the node 700a transmits capability information to a network entity 705. The capability information may comprise capability for determining one or more of the incidence power or angle profile and/or for determining a reflection strategy based on received task or optimization metrics may be provided to the network entity 705 prior to receiving a configuration from the network entity so that the configuration can be provided with respect to the measurement and transmission capabilities of the node 700a.

In some embodiments, an indication of the power or angle distribution of the incident (received) waves at the node 700a is further indicated to the node 700a as assisting information or determined at the node 700a (e.g., based on measurement of the first sensing signal). In some embodiments, the power or angle distribution of the incident waves at the node 700a is utilized to generate the reflection towards the reflection angle/beam with a maximum collected energy of the incidence signals.

In some examples, the node 700a comprises a first entity connected (via a 3GPP interface or independent from 3GPP interface) to another entity, e.g., a controller entity, and one or more of steps of receiving a first signal, measurement of the first signal and determining a value of a metric or condition, adjusting the transmission or reflection and performing transmission or reflection are conducted via the second entity. However, for the purpose of the current examples the radio node 700a may be viewed as a combination of both such entities and separation of the steps to be implemented by the entities are implicit with the described procedures.

In one such example, a RIS/repeater entity is further coupled to a UE or to another entity acting as controller of the RIS/repeater. In some examples, the sensing measurement and adjustment/determination of the reflection of the second signal are performed by the other entity, but the reflection of the second signal is implemented by the RIS/repeater entity. In another example, the reception and measurement of the first signal is performed by the repeater/RIS entity, and determination of the condition and reporting/indication of the determined condition/parameters are performed by the other entity. Accordingly two separate physical structures may be present to realize node 700a, e.g., a RIS and a controller entity.

In the above embodiments including examples of determining/adjusting of a transmission beam and/or transmission power parameters of a signal (exemplified as a physical data/control channel or a reference signal, as a sensing signal) the examples of the signal types (e.g., sensing signal or a physical data channel) are not intended to be exclusive, and the same processes may be applied to a second or a third signal type with any of one or more of a physical data, control, paging channel, sensing signal, or reference signal. Examples of a determined power parameter include determining a relative power, e.g., a power of all reflected or transmitted power of the second signal at all beams by the radio node or as an absolute Tx power of the beam.

In an aspect 1 of the present disclosure, a radio node, which may be an NCR or RIS, is indicated with a configuration within an indicated time resource.

In an aspect 1A, the radio node determines a reception/incidence beam/angle/depth of a reflection or re-transmission configuration as the angle or beam associated to the detected target or path of the measured first sensing signal.

In an aspect 1B, the radio node determines a reflection/re-transmission beam/angle of the reflection or re-transmission configuration as an angle or beam associated to the detected target or path of the measured first sensing signal.

In an aspect 1C, the configuration is determined based on an objective of maximizing reflection/re-transmission energy towards an indicated/determined retransmission/reflection angle/beam, or minimizing reflection/re-transmission energy towards an indicated/determined retransmission/reflection angle/beam.

In an aspect 1D, the radio node transmits an indication of RIS capability information comprising RIS sensing measurement capabilities, RIS capability for sensing-based adjustments, and supported reflection objectives for RIS.

In an aspect 2, for a radio node configured with determining a condition based on sensing measurements of a first signal, the radio node transmits a second sensing signal or a physical data channel conditioned on the determined condition including detection of a path, a sensing target (e.g., skipping a configured transmission when condition is detected to be not true); adjusts the Tx parameters of the second signal to the performed measurement of the first signal; adjusts the Tx beam of the second signal to the detected path/target of the first sensing signal (e.g., the Tx beam is QCLed with the detected path/target of the first signal); and adjust the Tx power of the second sensing signal based on the detected path and RSRPP reading of the detected path/target from the first signal.

In an aspect 3, for a radio node in a path round-trip time or round trip doppler measurement process, at least configured with reception of a first sensing signal (e.g., DL-PRS) and transmission of a second sensing signal (e.g., UL-SRS), the radio node skips or adjusting the configured UL SRS transmission based on measurement of the DL PRS.

In an aspect 4, a radio node or network entity performs one or more of reporting, measurement, or determination of a criteria based on a ratio of received signal power associated with a path/path group of a sensing target to collection of undesired power, including one or more of interference, noise, reception power (sum-RSRPP) of paths not associated with a target, measured based on reception of a sensing signal.

In an aspect 5, a radio node configured with transmission of at least two signals (e.g., including two sensing signals associated with different target areas, two physical data/control channels (associated with different beam/TRPs), a sensing signal and a physical data/control channel), the node determines multiplexing of the said two signals jointly based on the determined condition or measurement quantities.

In an aspect 6, a radio node based on sensing measurement determines a TCI state of a second signal including the second signal simultaneously QCL-ed (e.g., type D) with a first beam and further QCL-ed with a second beam, wherein the simultaneous QCL relationship further comprises a power/energy ratio between the first and the second simultaneous QCL relations, a timing ratio between the first and second beam.

An aspect 6A may include defining a composite beam from two known beams for a single coherent transmission wherein the first beam may enjoy a different beam direction/width, timing advance and energy within the same coherent transmission.

In an aspect 7, radio node capability indication for sensing measurement-based transmission configuration adjustments comprises a type of the supported Tx parameter adjustments, and/or associated required time delay for adjustments as a time window needed before reception of the first sensing signal until a configured transmission can be transmitted with configured adjustments.

In an aspect 7, a radio node sends an indication of a self-determined transmission or Tx parameter adjustments to a controller node or to a node receiving the Tx signal by the radio node (e.g., prior to the expected reception of the Tx signal by the recipient node within an indicated time distance).

In an aspect 8, a recipient node of the second sensing signal or the physical data/control channel does not receive indication of the (sensing-based) determined transmission of the second sensing signal or physical data/control channel by the radio node, and based on the detection of the second sensing signal or physical channel, implicitly infers the determined condition at the radio node.

In an aspect 9, a node for wireless communication with at least one memory has at least one processor coupled with the at least one memory and configured to cause the node to receive, from a network entity, a configuration comprising a first set of one or more parameters for reception and measurement of sensing signals and a second set of one or more parameters for transmission of signals, wherein at least one parameter of the first set of one or more parameters indicates a metric of the sensing signals for measurement, wherein at least one parameter of the second set of one or more parameters indicates at least one condition for outputting signals by transmitting or reflecting the output signals, receive a first sensing signal according to the received configuration, measure a value of the metric for the received first sensing signal according to the received configuration and determine at least one parameter associated with a second signal based at least in part on one or more of the measured value of the metric for the received first sensing signal and the at least one condition for outputting the second signal according to the received configuration.

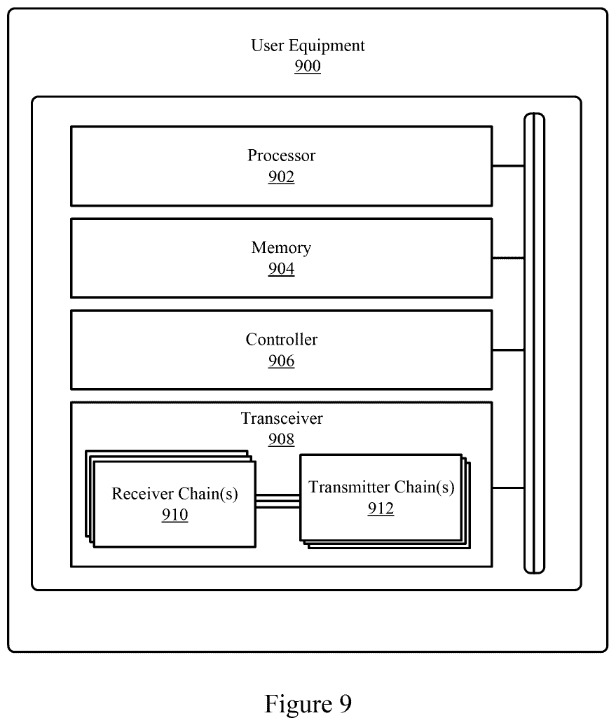

FIG. 9 illustrates an example of a UE 900 in accordance with aspects of the present disclosure. The UE 900 may include a processor 902, a memory 904, a controller 906, and a transceiver 908. The processor 902, the memory 904, the controller 906, or the transceiver 908, or various combinations thereof or various components thereof may be examples of means for performing various aspects of the present disclosure as described herein. These components may be coupled (e.g., operatively, communicatively, functionally, electronically, electrically) via one or more interfaces.

The processor 902, the memory 904, the controller 906, or the transceiver 908, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 902 may include an intelligent hardware device (e.g., a general-purpose processor, a DSP, a CPU, an ASIC, an FPGA, or any combination thereof). In some implementations, the processor 902 may be configured to operate the memory 904. In some other implementations, the memory 904 may be integrated into the processor 902. The processor 902 may be configured to execute computer-readable instructions stored in the memory 904 to cause the UE 900 to perform various functions of the present disclosure.

The memory 904 may include volatile or non-volatile memory. The memory 904 may store computer-readable, computer-executable code including instructions when executed by the processor 902 cause the UE 900 to perform various functions described herein. The code may be stored in a non-transitory computer-readable medium such the memory 904 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 902 and the memory 904 coupled with the processor 902 may be configured to cause the UE 900 to perform one or more of the functions described herein (e.g., executing, by the processor 902, instructions stored in the memory 904). For example, the processor 902 may support wireless communication at the UE 900 in accordance with examples as disclosed herein. The UE 900 may be configured to support a means for performing conditional sensing operations.

The controller 906 may manage input and output signals for the UE 900. The controller 906 may also manage peripherals not integrated into the UE 900. In some implementations, the controller 906 may utilize an operating system such as iOS®, ANDROID®, WINDOWS®, or other operating systems. In some implementations, the controller 906 may be implemented as part of the processor 902.

In some implementations, the UE 900 may include at least one transceiver 908. In some other implementations, the UE 900 may have more than one transceiver 908. The transceiver 908 may represent a wireless transceiver. The transceiver 908 may include one or more receiver chains 910, one or more transmitter chains 912, or a combination thereof.

A receiver chain 910 may be configured to receive signals (e.g., control information, data, packets) over a wireless medium. For example, the receiver chain 910 may include one or more antennas for receive the signal over the air or wireless medium. The receiver chain 910 may include at least one amplifier (e.g., a low-noise amplifier (LNA)) configured to amplify the received signal. The receiver chain 910 may include at least one demodulator configured to demodulate the receive signal and obtain the transmitted data by reversing the modulation technique applied during transmission of the signal. The receiver chain 910 may include at least one decoder for decoding the processing the demodulated signal to receive the transmitted data.

A transmitter chain 912 may be configured to generate and transmit signals (e.g., control information, data, packets). The transmitter chain 912 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 912 may also include at least one power amplifier configured to amplify the modulated signal to an appropriate power level suitable for transmission over the wireless medium. The transmitter chain 912 may also include one or more antennas for transmitting the amplified signal into the air or wireless medium.

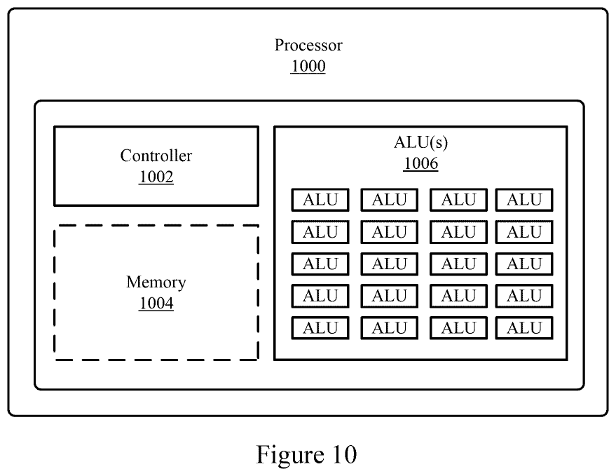

FIG. 10 illustrates an example of a processor 1000 in accordance with aspects of the present disclosure. The processor 1000 may be an example of a processor configured to perform various operations in accordance with examples as described herein. The processor 1000 may include a controller 1002 configured to perform various operations in accordance with examples as described herein. The processor 1000 may optionally include at least one memory 1004, which may be, for example, an L1/L2/L3 cache. Additionally, or alternatively, the processor 1000 may optionally include one or more arithmetic-logic units (ALUs) 1006. One or more of these components may be in electronic communication or otherwise coupled (e.g., operatively, communicatively, functionally, electronically, electrically) via one or more interfaces (e.g., buses).

The processor 1000 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1000) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1002 may be configured to manage and coordinate various operations (e.g., signaling, receiving, obtaining, retrieving, transmitting, outputting, forwarding, storing, determining, identifying, accessing, writing, reading) of the processor 1000 to cause the processor 1000 to support various operations in accordance with examples as described herein. For example, the controller 1002 may operate as a control unit of the processor 1000, generating control signals that manage the operation of various components of the processor 1000. These control signals include enabling or disabling functional units, selecting data paths, initiating memory access, and coordinating timing of operations.

The controller 1002 may be configured to fetch (e.g., obtain, retrieve, receive) instructions from the memory 1004 and determine subsequent instruction(s) to be executed to cause the processor 1000 to support various operations in accordance with examples as described herein. The controller 1002 may be configured to track memory address of instructions associated with the memory 1004. The controller 1002 may be configured to decode instructions to determine the operation to be performed and the operands involved. For example, the controller 1002 may be configured to interpret the instruction and determine control signals to be output to other components of the processor 1000 to cause the processor 1000 to support various operations in accordance with examples as described herein. Additionally, or alternatively, the controller 1002 may be configured to manage flow of data within the processor 1000. The controller 1002 may be configured to control transfer of data between registers, arithmetic logic units (ALUs), and other functional units of the processor 1000.

The memory 1004 may include one or more caches (e.g., memory local to or included in the processor 1000 or other memory, such RAM, ROM, DRAM, SDRAM, SRAM, MRAM, flash memory, etc. In some implementations, the memory 1004 may reside within or on a processor chipset (e.g., local to the processor 1000). In some other implementations, the memory 1004 may reside external to the processor chipset (e.g., remote to the processor 1000).

The memory 1004 may store computer-readable, computer-executable code including instructions that, when executed by the processor 1000, cause the processor 1000 to perform various functions described herein. The code may be stored in a non-transitory computer-readable medium such as system memory or another type of memory. The controller 1002 and/or the processor 1000 may be configured to execute computer-readable instructions stored in the memory 1004 to cause the processor 1000 to perform various functions. For example, the processor 1000 and/or the controller 1002 may be coupled with or to the memory 1004, the processor 1000, the controller 1002, and the memory 1004 may be configured to perform various functions described herein. In some examples, the processor 1000 may include multiple processors and the memory 1004 may include multiple memories. One or more of the multiple processors may be coupled with one or more of the multiple memories, which may, individually or collectively, be configured to perform various functions herein.

The one or more ALUs 1006 may be configured to support various operations in accordance with examples as described herein. In some implementations, the one or more ALUs 1006 may reside within or on a processor chipset (e.g., the processor 1000). In some other implementations, the one or more ALUs 1006 may reside external to the processor chipset (e.g., the processor 1000). One or more ALUs 1006 may perform one or more computations such as addition, subtraction, multiplication, and division on data. For example, one or more ALUs 1006 may receive input operands and an operation code, which determines an operation to be executed. One or more ALUs 1006 be configured with a variety of logical and arithmetic circuits, including adders, subtractors, shifters, and logic gates, to process and manipulate the data according to the operation. Additionally, or alternatively, the one or more ALUs 1006 may support logical operations such as AND, OR, exclusive-OR (XOR), not-OR (NOR), and not-AND (NAND), enabling the one or more ALUs 1006 to handle conditional operations, comparisons, and bitwise operations.

The processor 1000 may support wireless communication in accordance with examples as disclosed herein. The processor 1000 may be configured to or operable to support a means for performing conditional sensing operations.

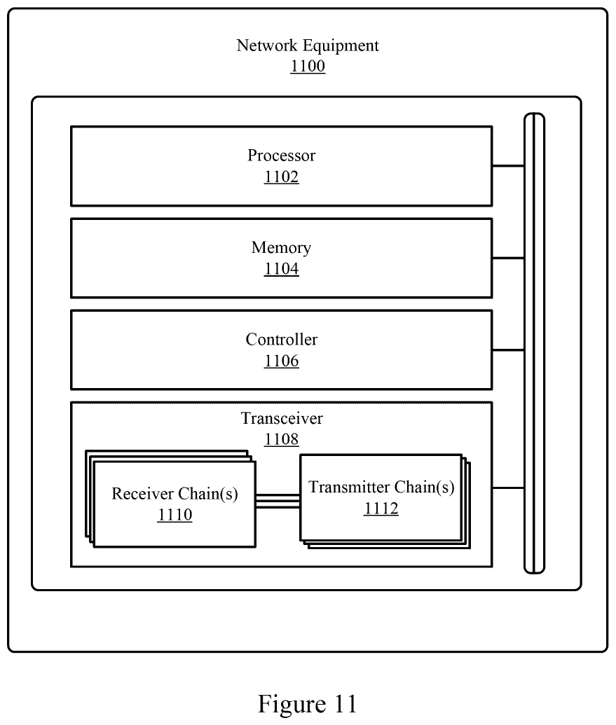

FIG. 11 illustrates an example of a NE 1100 in accordance with aspects of the present disclosure. The NE 1100 may include a processor 1102, a memory 1104, a controller 1106, and a transceiver 1108. The processor 1102, the memory 1104, the controller 1106, or the transceiver 1108, or various combinations thereof or various components thereof may be examples of means for performing various aspects of the present disclosure as described herein. These components may be coupled (e.g., operatively, communicatively, functionally, electronically, electrically) via one or more interfaces.

The processor 1102, the memory 1104, the controller 1106, or the transceiver 1108, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1102 may include an intelligent hardware device (e.g., a general-purpose processor, a DSP, a CPU, an ASIC, an FPGA, or any combination thereof). In some implementations, the processor 1102 may be configured to operate the memory 1104. In some other implementations, the memory 1104 may be integrated into the processor 1102. The processor 1102 may be configured to execute computer-readable instructions stored in the memory 1104 to cause the NE 1100 to perform various functions of the present disclosure.

The memory 1104 may include volatile or non-volatile memory. The memory 1104 may store computer-readable, computer-executable code including instructions when executed by the processor 1102 cause the NE 1100 to perform various functions described herein. The code may be stored in a non-transitory computer-readable medium such the memory 1104 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1102 and the memory 1104 coupled with the processor 1102 may be configured to cause the NE 1100 to perform one or more of the functions described herein (e.g., executing, by the processor 1102, instructions stored in the memory 1104). For example, the processor 1102 may support wireless communication at the NE 1100 in accordance with examples as disclosed herein. The NE 1100 may be configured to support a means for performing conditional sensing operations.

The controller 1106 may manage input and output signals for the NE 1100. The controller 1106 may also manage peripherals not integrated into the NE 1100. In some implementations, the controller 1106 may utilize an operating system such as iOS®, ANDROID®, WINDOWS®, or other operating systems. In some implementations, the controller 1106 may be implemented as part of the processor 1102.

In some implementations, the NE 1100 may include at least one transceiver 1108. In some other implementations, the NE 1100 may have more than one transceiver 1108. The transceiver 1108 may represent a wireless transceiver. The transceiver 1108 may include one or more receiver chains 1110, one or more transmitter chains 1112, or a combination thereof.

A receiver chain 1110 may be configured to receive signals (e.g., control information, data, packets) over a wireless medium. For example, the receiver chain 1110 may include one or more antennas for receiving the signal over the air or wireless medium. The receiver chain 1110 may include at least one amplifier (e.g., a low-noise amplifier (LNA)) configured to amplify the received signal. The receiver chain 1110 may include at least one demodulator configured to demodulate the received signal and obtain the transmitted data by reversing the modulation technique applied during transmission of the signal. The receiver chain 1110 may include at least one decoder for decoding the processing the demodulated signal to receive the transmitted data.

A transmitter chain 1112 may be configured to generate and transmit signals (e.g., control information, data, packets). The transmitter chain 1112 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1112 may also include at least one power amplifier configured to amplify the modulated signal to an appropriate power level suitable for transmission over the wireless medium. The transmitter chain 1112 may also include one or more antennas for transmitting the amplified signal into the air or wireless medium.

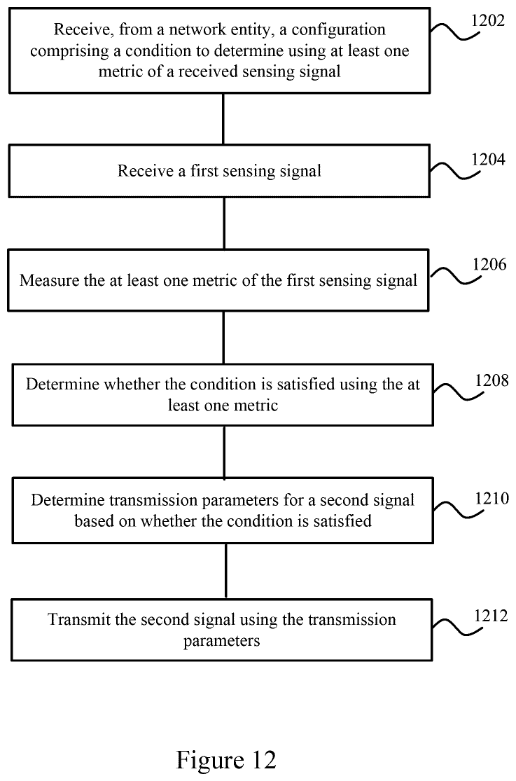

FIG. 12 illustrates a flowchart of a method in accordance with aspects of the present disclosure. The operations of the method may be implemented by a node as described herein. In some implementations, the node may execute a set of instructions to control the function elements of the node to perform the described functions.

At 1202, the method may include receiving, from a network entity, a configuration comprising a condition to determine using at least one metric of a received sensing signal. The operations of 1202 may be performed in accordance with examples as described herein. In some implementations, aspects of the operations of 1202 may be performed by a node as described with reference to FIG. 7.

At 1204, the method may include receiving a first sensing signal. The operations of 1204 may be performed in accordance with examples as described herein. In some implementations, aspects of the operations of 1204 may be performed by a node as described with reference to FIG. 7.

At 1206, the method may include measuring the at least one metric of the first sensing signal. The operations of 1206 may be performed in accordance with examples as described herein. In some implementations, aspects of the operations of 1206 may be performed by a node as described with reference to FIG. 7.
measure the at least one metric of the first sensing signal;

At 1208, the method may include determining whether the condition is satisfied using the at least one metric. The operations of 1208 may be performed in accordance with examples as described herein. In some implementations, aspects of the operations of 1208 may be performed by a node as described with reference to FIG. 7.

At 1210, the method may include determining transmission parameters for a second signal based on the determination of whether the condition is satisfied. The operations of 1210 may be performed in accordance with examples as described herein. In some implementations, aspects of the operations of 1210 may be performed by a node as described with reference to FIG. 7.

At 1212, the method may include transmitting the second signal using the transmission parameters. The operations of 1212 may be performed in accordance with examples as described herein. In some implementations, aspects of the operations of 1212 may be performed by a node as described with reference to FIG. 7.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A radio node for wireless communication, comprising:
at least one memory; and
at least one processor coupled with the at least one memory and configured to cause the radio node to:
receive, from a network entity, a configuration comprising a condition for outputting a second signal using at least one metric of a received sensing signal;
receive a first sensing signal;
measure the at least one metric of the first sensing signal;
determine whether the condition is satisfied using the at least one metric;
determine transmission parameters for a second signal based on the determination of whether the condition is satisfied; and
transmit the second signal using the transmission parameters.

2. The radio node of claim 1, wherein the configuration further comprises at least one of parameters for receiving the first sensing signal and the at least one metric.

3. The radio node of claim 1, wherein the condition comprises at least one of:
a target, a path or a path group being present;
a measurement value being larger than a threshold value;
a measurement value being smaller than a threshold value; and
a feature of a detected object being present.

4. The radio node of claim 3, wherein the at least one processor is further configured to cause the radio node to:
measure a power value of the first sensing signal;
compare the power value to a first threshold value and a second threshold value; and
when the measured power value is above the first threshold value and below the second threshold value, use a transmission power that is higher than the measured power value to transmit the second signal.

5. The radio node of claim 1, wherein the at least one metric of the first sensing signal is at least one of an angle of arrival and an azimuth of arrival, and the at least one processor is further configured to cause the radio node to:
measure the at least one of the angle of arrival and the azimuth of arrival of the first sensing signal; and
transmit the second signal in a direction corresponding to the at least one of the angle of arrival and the azimuth of arrival.

6. The radio node of claim 1, wherein the radio node is associated with a radio access technology (RAT)-independent sensor, and
wherein the at least one processor is further configured to cause the RAT-independent sensor to sense a target or features of a target.

7. The radio node of claim 6, wherein the configuration further comprises instructions for sensing a detected object using the RAT-independent sensor, and
wherein the at least one processor is further configured to cause the radio node to:
transmit, to the network entity, a signal indicating at least one of a type, a capability, and sensing data of the RAT-independent sensor.

8. The radio node of claim 6, wherein the at least one processor is further configured to cause the radio node to:
determine at least one of whether the condition is satisfied and the transmission parameters for the second signal using sensing data from sensing the target or features of the target with the RAT-independent sensor.

9. The radio node of claim 1, wherein the second signal is a carrier wave for a backscattering device.

10. The radio node of claim 1, wherein the second signal is a paging signal for paging a second radio node at a location of a detected object or a communication signal transmitted on a physical control channel for communicating with the second radio node at the location of the detected object.

11. The radio node of claim 1, wherein the second signal is a sounding reference signal (SRS) or a positioning reference signal (PRS).

12. The radio node of claim 1, wherein the configuration from the network entity further comprises information for transmitting a third signal that shares radio resources with the second signal, and
wherein the at least one processor is further configured to cause the radio node to:
transmit the third signal based on the configuration received from the network entity.

13. The radio node of claim 11, wherein the third signal is duplexed with the second signal in the time domain, and the third signal is transmitted to a second radio node.

14. The radio node of claim 1, wherein the at least one processor is further configured to cause the radio node to:
transmit a signal indicating the determined transmission parameters for the second signal to at least one of the network entity, a recipient of the second signal, and a second radio node.

15. The radio node of claim 1, wherein the at least one processor is further configured to cause the radio node to:
measure a first power value associated with a path to a target;
measure a second power value of received power not associated with the path to the target; and
transmit, to the network entity, an indication of the first power value and the second power value.

16. A processor for wireless communication, comprising:
at least one controller coupled with at least one memory and configured to cause the processor to:
receive, from a network entity, a configuration comprising a condition for outputting a second signal using at least one metric of a received sensing signal;
receive a first sensing signal;
measure the at least one metric of the first sensing signal;
determine whether the condition is satisfied using the at least one metric;
determine transmission parameters for a second signal based on the determination of whether the condition is satisfied; and
transmit the second signal using the transmission parameters.

17. The processor of claim 16, wherein the at least one metric of the first sensing signal is at least one of an angle of arrival and an azimuth of arrival, and the at least one processor is further configured to cause the radio node to:
measure the at least one of the angle of arrival and the azimuth of arrival of the first sensing signal; and
transmit the second signal in a direction corresponding to the at least one of the angle of arrival and the azimuth of arrival.

18. The processor of claim 16, wherein the processor is associated with a radio access technology (RAT)-independent sensor, and
wherein the at least one processor is further configured to cause the RAT-independent sensor to sense a target or features of a target.

19. The processor of claim 16, wherein the second signal is a paging signal for paging a second radio node at a location of a detected object or a communication signal transmitted on a physical control channel to the second radio node at the location of the detected object.

20. A base station for wireless communication, comprising:
at least one memory; and
at least one processor coupled with the at least one memory and configured to cause the base station to:
receive, from a network entity, a configuration comprising a condition for outputting a second signal using at least one metric of a received sensing signal;
receive a first sensing signal;
measure the at least one metric of the first sensing signal;
determine whether the condition is satisfied using the at least one metric;
determine transmission parameters for a second signal based on the determination of whether the condition is satisfied; and
transmit the second signal using the transmission parameters.
